(19) United States
(12) Patent Application Publication
(10) Pub. No.: US 2025/0113933 A1
(43) Pub. Date: Apr. 10, 2025

(54) DISPLAY UNITS FOR LITHOPHANES

(71) Applicant: Jacob A. Kelsey, Longmont, CO (US)

(72) Inventor: Jacob A. Kelsey, Longmont, CO (US)

(21) Appl. No.: 18/948,458

(22) Filed: Nov. 14, 2024

Related U.S. Application Data
(63) Continuation-in-part of application No. 18/662,763, filed on May 13, 2024, now Pat. No. 12,179,511.
(60) Provisional application No. 63/559,064, filed on Feb. 28, 2024.
(60) Provisional application No. 63/467,997, filed on May 21, 2023.

(51) Int. Cl. A47G 1/14; F21V 3/00; F21V 23/04; F21W 131/304; F21Y 103/10

(52) U.S. Cl. CPC A47G 1/14; F21V 3/00; F21V 23/04; A47G 2001/147; F21W 2131/304; F21Y 2103/10

(57) ABSTRACT

Display units for lithophanes and methods for manufacturing them. A display unit may include a pane, or a stand piece, formed of a clear or translucent material of construction. At least a portion of a frontward-facing surface of the pane or the stand piece may include a roughened surface formed thereon. The display unit may include at least one light source positioned sufficiently proximate to, or in contact with, one or more edges of the pane or the stand piece to direct light from the at least one light source as at least one light path into and through the clear or translucent material of construction toward the roughened surface. The display unit may include means for positioning a lithophane upon, or proximate, to the roughened surface. Users of such display units may experience greater lithophane viewing convenience using either natural light or with the at least one light source.

### CROSS-REFERENCE TO RELATED APPLICATIONS

This application is a continuation-in-part of U.S. patent application Ser. No. 18/662,763 filed in May 13, 2024, which claims the benefit of and priority to U.S. Provisional Patent Application 63/559,064, filed Feb. 28, 2024 and U.S. Provisional Patent Application No. 63/467,997, filed May 21, 2023; the entire contents of each of which is incorporated by reference herein.

### BACKGROUND

Lithophanes may be created using three-dimensional (3D) printing techniques by converting a two-dimensional (2D) image to a 3D height map. In this known technique, darker pixels in the image may be translated to thicker material in the 3D part. Conversely, lighter pixels are converted to thinner material. In a known process for visualizing an image so translated and/or converted, when the resulting 3D printed lithophane is back lit by natural daylight or by an artificial light source, the original image translated onto the lithophane may be visible in gray tone. FIG. 1 shows a 3D printed lithophane 10 being backlit by sunlight through a window according to the known visualization process.

In the known technique for visualizing images of a 3D printed lithophane, the backlighting required is natural daylight or some artificial light source light like an electric light, or even a candle, placed behind the lithophane. Such artificial light sources are required at night or in a darkened interior room. It may be inconvenient for people to position such light sources, or the 3D printed lithophanes themselves, in this manner. Furthermore, when there is no daylight available, such an artificial light source may be required to see the image of the 3D printed lithophane. A person may need to hold the 3D printed lithophane up to the light, which may also be inconvenient and cumbersome. As such, use of the known techniques for visualizing images of a 3D printed lithophane may limit the potential usability and enjoyment of users. These or similar drawbacks may exist for users of lithophanes other than those that are 3D printed.

Accordingly, a need exists for technology that overcomes the problem demonstrated above, as well as one that provides additional benefits. The examples provided herein of some prior or related systems and their associated limitations are intended to be illustrative and not exclusive. Other limitations of existing or prior systems will become apparent to those of skill in the art upon reading the following Detailed Description.

### SUMMARY

A first aspect of the disclosure provides a display unit for lithophanes. The display unit may include a base including an opening formed in a portion of a top surface of the base. The display unit may include a receptacle extending downward from the opening and into a portion of the base. The display unit may include a light source positioned at or proximal to a bottom of the receptacle. The display unit may include a stand piece having a top and a bottom. The bottom of the stand piece may be configured to be inserted into the receptacle to bring the bottom of the stand piece in contact with or in proximity to the light source. The stand piece may include a roughened surface formed on at least a portion of a front side of the stand piece. The stand piece may include a pair of structures disposed on opposing sides of the stand piece and extending from a top of the stand piece to or proximate to the bottom of the stand piece. The pair of structures may include a pair of slots extending from tops of the structures to bottoms of the structures. The slots may be configured for, or otherwise capable of, receiving opposing sides of a lithophane.

In some embodiments, the display unit according to the first aspect of the disclosure may include a power supply operably coupled to the light source. In some embodiments, the base of the display unit may include an interior cavity, and the power supply may be disposed at least in part inside the interior cavity. In some embodiments, the display unit may include at least one button (or switch, or similar device) positioned in or on the base so as to be accessible to a user during use of the display unit. In an example, the at least one button may be operably coupled to the power supply and/or to the light source to enable the user to alternately turn the light source on and turn the light source off.

The display unit may include at least one button or other means (e.g., knob or slider) for adjusting brightness of the light source. The at least one button or other means may be positioned in or on the base and accessible to a user during use of the display unit. The at least one button may be operably coupled to the power supply and/or to the light source to enable the user to alternately increase and decrease the brightness of the light source. In some embodiments, the light source of the display unit according to the first aspect of the disclosure may include a strip of a plurality of LED lamps or lights. The at least one button may also allow changing the color of the plurality of LED lights, as well as toggling through various multi-color effects, such as color wipes and fades, candle flicker and fireworks simulation, etc.

In some embodiments, at least a portion of a front side of the stand piece on which the roughened surface may be formed is clear or translucent. In an example, an entirety of the stand piece may be formed or otherwise made of a clear or translucent material of construction. In some embodiments, a material of construction of at least a portion of the base is an opaque material. In an example, a bottom of the base may be flat. In some embodiments, the receptacle of the display unit according to the first aspect may include interior walls.

A second aspect of the disclosure provides a method for manufacturing a display unit for lithophanes. The method may include the step of forming a receptacle in a portion of a base of the display unit. The step of forming the receptacle may include: forming an opening in a portion of a top surface of the base; and extending the receptacle downward from the opening into a portion of the base. The method may include the step of positioning a light source at or proximal to a bottom of the receptacle. The method may include the step of forming a stand piece having a top and a bottom, and with the bottom of the stand piece being configured to be, or otherwise capable of being, inserted into the receptacle. The step of forming the stand piece may include: forming a roughened surface on at least a portion of a front side of the stand piece; and forming a pair of structures disposed on opposing sides of the stand piece and extending from a top of the stand piece to or proximate to the bottom of the stand piece. The step of forming the pair of structures may include the step of creating a pair of slots extending from tops of the structures to bottoms of the structures. The slots may be configured for, or otherwise capable of, receiving opposing sides of a lithophane. The method may include the step of forming the portion of the stand piece front surface which is roughened at a slight (e.g., 1-2 degrees) backward angle. The aforementioned backward angle may be greater than 0 degrees and less than or equal to 5 degrees.

In some embodiments, the method according to the second aspect of the disclosure may include the step of inserting the bottom of the stand piece into the receptacle to bring the bottom of the stand piece in contact with or in proximity to the light source. In some embodiments, the method may include the step of operably coupling the light source to a power supply. In an example, the base may include an interior cavity, and the method may include the step of positioning the power supply at least in part inside the interior cavity. In some embodiments, the method may also include the steps of: positioning at least one button or switch in or on the base to be accessible to a user during use of the display unit; and operably coupling the at least one button or switch to the power supply and/or to the light source to enable the user to alternately turn the light source on and turn the light source off.

In some embodiments, the method step of positioning the light source may include positioning a strip of a plurality of LED lamps or lights at or proximal to a bottom of the receptacle. In some embodiments, the method may include the steps of: positioning at least one button or other means for adjusting a brightness of the light source in or on the base to be accessible to a user during use of the display unit; and operably coupling the at least one button or other means for adjusting a brightness of the light source to enable the user to alternately increase and decrease the brightness of the light source. In some embodiments, the method may include the step(s) of positioning additional button(s) or other means for toggling through different colors and operating modes and dynamic color effects.

In some embodiments, the method step of forming the roughened surface may include forming the roughened surface on the at least a portion of a front side of the stand piece that is clear or translucent. In some embodiments, the portion of the roughened surface may be sloped backward at a slight (e.g., 1-2 degrees) angle. The method step of forming the stand piece may include forming the portion of the stand piece having the roughened surface at the aforementioned sloped backward angle of greater than 0 degrees and less than or equal to 5 degrees. In some embodiments, the method step of forming the stand piece may include forming the stand piece of a clear or translucent material of construction.

In some embodiments, the method may include the step of forming the base. In an example, the step of forming the base may include forming the base having a flat bottom. In another example, the step of forming the base may include forming at least a portion of the base of an opaque material of construction. In some embodiments of the method according to the second aspect of the disclosure, the method step of forming the receptacle may include forming the receptacle having interior walls.

A third aspect of the disclosure provides a display unit for lithophanes. The display unit may include a pane or a stand piece formed of a clear or translucent material of construction. At least a portion of a frontward-facing surface of the pane or the stand piece may include a roughened surface formed thereon. The display unit may include at least one light source positioned sufficiently proximate to, or in contact with, one or more edges of the pane or the stand piece to direct light from the at least one light source as at least one light path into and through the clear or translucent material of construction toward the roughened surface. The display unit may include means for positioning a lithophane upon, or proximate, to the roughened surface.

In some embodiments, the display unit according to the third aspect of the disclosure may include means for positioning a lithophane upon, or proximate, to the roughened surface. The means for positioning the lithophane may be configured to enable or facilitate, or otherwise capable of enabling or facilitating, a removable placement of the lithophane by a user into the display unit. In some embodiments, the display unit may include the stand piece having a top and a bottom, and the display unit may further include: a base having an opening formed in a portion of a top surface of the base; and a receptacle extending downward from the opening and into a portion of the base. In some embodiments, at least a portion of a bottom of the base may be flat. In some embodiments, a material of construction of at least a portion of the base may be an opaque material.

In some embodiments, the at least one light source may be positioned at or proximal to a bottom of the receptacle. In some embodiments, the bottom of the stand piece may be configured to be, or otherwise capable of being, inserted into the receptacle to bring the bottom of the stand piece in contact with or in proximity to the at least one light source.

In some embodiments, the means for positioning the lithophane upon, or proximate, to the roughened surface may be disposed in or on a portion of the frontward-facing surface of the stand piece. In some embodiments, the means for positioning the lithophane upon, or proximate, to the roughened surface is disposed in or on both a portion of the frontward-facing surface of the stand piece and a portion of the top surface of the base.

In some embodiments, the display unit may include a power supply operably coupled to the at least one light source. In some embodiments, the display unit may include at least one of: means for alternately turning the at least one light source on and off positioned sufficiently to be accessible to a user during use of the display unit, and operably coupled to at least one of the power supply and the at least one light source; and at least one button, dial, knob, or other means for adjusting a brightness of the at least one light source positioned sufficiently to be accessible to a user during use of the display unit, and operably coupled to at least one of the power supply and the at least one light source.

In some embodiments, the at least a portion of a frontward-facing surface including the roughened surface may be angled backward from front to back (e.g., by any of the angles (“A”) summarized above for the first aspect of the disclosure). In some embodiments, the at least one light source may include a strip of a plurality of light emitting diodes (LEDs). In some embodiments, the at least one light source comprises two or more light sources including a first light source positioned proximate to, or in contact with, to a first edge of the pane or the stand piece, and at least a second light source positioned proximate to, or in contact with, to at least a second edge of the pane or the stand piece.

In some embodiments, the display unit may include the pane. In some embodiments, the display unit may include a frame having a frontward-facing opening and configured to contain at least part of the pane such that the at least a portion of a frontward-facing surface of the pane including the roughened surface may be viewable from an exterior of the frame through a frontward-facing opening of the frame. The pane may be removably contained in or on the frame. The frame may be embodied in a frame assembly having a plurality of frame pieces that may be removably coupled, or coupleable, to one another. Such examples may facilitate maintenance by a user of the pane, light source(s), or power supply or other electronic components. In an example, the aforementioned frontward-facing opening of the frame may itself be configured to be, or otherwise capable of being, covered by a protective covering (e.g., a sheet of clear glass or clear plastic).

In some embodiments, the means for positioning the lithophane upon, or proximate, to the roughened surface may be disposed in or on a portion of the frontward-facing surface of the pane. In some embodiments, the means for positioning the lithophane upon, or proximate, to the roughened surface may be additionally disposed in or on a portion of the frame. In some embodiments, the means for positioning the lithophane upon, or proximate, to the roughened surface may be disposed in or on a portion of the frame. In some embodiments, a material of construction of at least a portion of the frame may be an opaque material.

A fourth aspect of the disclosure provides a display unit for lithophanes. The display unit may include a pane formed of a clear or translucent material of construction. At least a portion of a frontward-facing surface of the pane or the stand piece may include a roughened surface formed thereon. The display unit may include a frame having a frontward-facing opening and configured to contain, or otherwise capable of containing, at least part of the pane such that the at least a portion of a frontward-facing surface of the pane including the roughened surface may be viewable from an exterior of the frame through the frontward-facing opening of the frame. The display unit may include at least one light source positioned sufficiently proximate to, or in contact with, one or more edges of the pane to direct light from the at least one light source as at least one light path into and through the clear or translucent material of construction toward the roughened surface.

In some embodiments, the display unit according to the fourth aspect of the disclosure may include means for positioning a lithophane upon, or proximate, to the roughened surface. In some embodiments, the means for positioning the lithophane upon, or proximate, to the roughened surface may be disposed in or on at least one of: a portion of the frontward-facing surface of the pane; and a portion of the frame.

A fifth aspect of the disclosure provides a method of manufacturing a display unit for lithophanes. The method may include the step of forming a pane or a stand piece of a clear or translucent material of construction. The forming step of the method may include forming a roughened surface on at least a portion of a surface of the pane that is frontward-facing during operation of the display unit. Forming the roughened surface in the method may be performed concurrently with, or after, the performance of the method step of forming the stand piece. The method may include the step of positioning at least one light source sufficiently proximate to, or in contact with, one or more edges of the pane to enable, during operation of the display unit, light to be directed from the at least one light source as at least one light path into and through the clear or translucent material of construction toward the roughened surface.

In some embodiments, the method according to the fifth aspect of the disclosure may include the step of forming or otherwise providing means for positioning a lithophane upon, or proximate, to the roughened surface. In some embodiments, the method step of forming or otherwise providing means for positioning the lithophane upon, or proximate, to the roughened surface may include forming or otherwise providing the means for positioning the lithophane in or on the at least a portion of the surface of the pane that is frontward-facing.

In some embodiments, the method may include the steps of: forming or otherwise providing a frame having a frontward-facing opening during operation of the display unit; and positioning the pane sufficiently in or on the frame to be contained at least in part therein such that the at least a portion of the surface of the pane that is frontward-facing and includes the roughened surface may be viewable from an exterior of the frame through the frontward-facing opening of the frame. In some embodiments, the method step of forming or otherwise providing means for positioning the lithophane upon, or proximate, to the roughened surface may include forming or otherwise providing the means for positioning the lithophane in or on a portion of at least one of: the frame; and the at least a portion of the surface of the pane that is frontward-facing.

### BRIEF DESCRIPTION OF THE DRAWINGS

One or more embodiments of the present invention are illustrated by way of example and not limitation in the figures of the accompanying drawings, in which like references indicate similar elements. The depictions of embodiments in the appended drawings are not necessarily drawn to scale.

FIG. 1 depicts a 3D printed lithophane being backlit by natural daylight through a window according to a known visualization process.

FIG. 2 is a perspective view of a display unit for lithophanes according to some embodiments of the present technology.

FIG. 3 is an exploded view in perspective of the display unit shown in FIG. 2.

FIG. 4 is a perspective view of a display unit for lithophanes with a lithophane positioned for insertion into slots according to some embodiments of the present technology.

FIG. 5 is a top view of a base of a display unit for lithophanes according to some embodiments of the present technology.

FIG. 6 is a side view of a portion of a receptacle of a base of a display unit according to some embodiments of the present technology.

FIG. 7 is a perspective view of a display unit for lithophanes according to some embodiments of the present technology.

FIG. 8 depicts the display unit of FIG. 7 in a darkened room with a white light source turned on without an inserted lithophane.

FIG. 9 is a perspective view of a portion of a multi-functional stand piece of a display unit according to some embodiments of the present technology.

FIG. 10 depicts the lithophane shown in FIG. 1 being backlit by natural daylight while positioned in a display unit according to some embodiments of the present technology.

FIG. 11 depicts another lithophane being backlit in a darkened room using a white light source of a display unit according to some embodiments of the present technology.

FIG. 12 depicts another lithophane being backlit in a darkened room with a variable color light source of a display unit according to some embodiments of the present technology.

FIG. 13 depicts an image of white noise that may be used to create a roughened surface on the front side of the stand piece for use in a display unit according to some embodiments of the present technology.

FIG. 14 is a side sectional view of the stand piece depicting an angled front surface for use in a display unit according to some embodiments of the present technology.

FIG. 15 is a flow chart of a method of manufacturing a display unit for lithophanes according to some embodiments of the present technology.

FIG. 16 is a perspective view of a display unit for lithophanes according to other embodiments of the present technology.

FIGS. 17A and 17B are side views of the display unit for lithophanes shown in FIG. 16 according to some embodiments of the present technology.

FIG. 18 is a perspective view rendering of the display unit shown in FIG. 17B.

FIG. 19 is a flow chart of a method of manufacturing a display unit for lithophanes according to other embodiments of the present technology.

FIG. 20 is a perspective view of a display unit (with frame attached) for lithophanes according to some additional embodiments of the present technology.

FIG. 21 is exploded view (with frame removed) in perspective of the display unit shown in FIG. 20.

FIG. 22 is a perspective view rendering of the display unit (with frame attached) shown in FIG. 20.

FIG. 23 is a side view of the display unit shown in FIG. 22 according to one embodiment of the present technology.

FIG. 24 is a side view of the display unit shown in FIG. 22 according to another embodiment of the present technology.

FIG. 25 is a side view of the display unit shown in FIG. 22 according to yet another embodiment of the present technology.

FIG. 26 is a side view of the display unit shown in FIG. 22 according to still another embodiment of the present technology.

FIG. 27 is a perspective view of a framed display unit for lithophanes according to some embodiments of the present technology.

FIG. 28 is a perspective view rendering of the display unit shown in FIG. 27.

FIG. 29 is a flow chart of a method of manufacturing a display unit for lithophanes according to still other embodiments of the present technology.

### DETAILED DESCRIPTION

following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but no other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

Embodiments of the present disclosure provide devices and techniques for visualizing 3D printed lithophanes. The disclosed display units enable an image present in a lithophane to be viewed by both natural daylight during the day and by an artificial light source in the dark or at night. As can be appreciated persons having ordinary skill in the art, the embodiments described herein according to the present technology may be advantageously practiced for lithophanes of various types other than 3D printed lithophanes without undue experimentation.

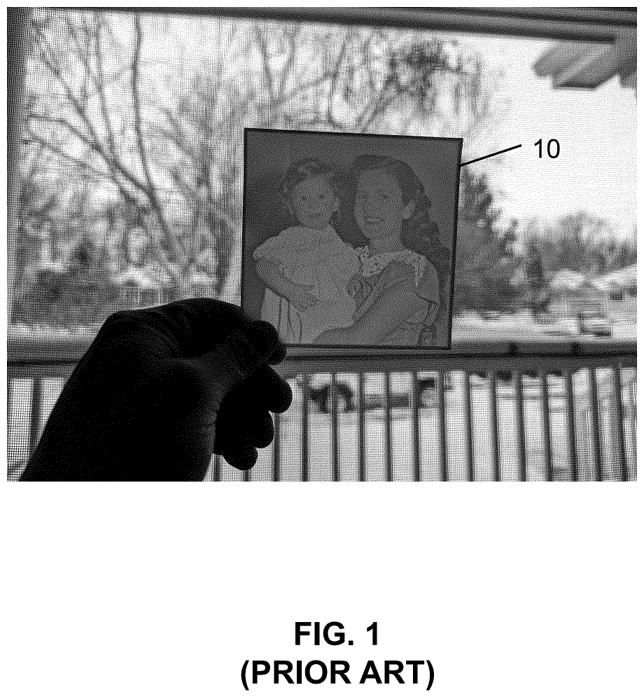

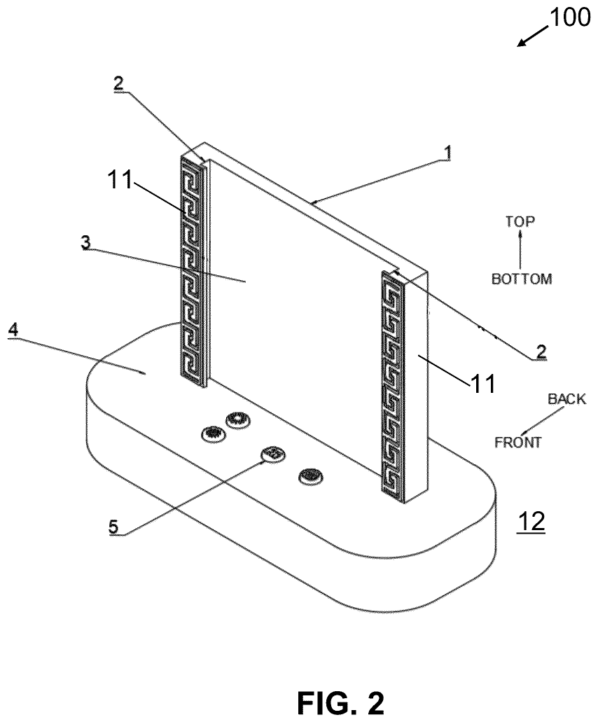

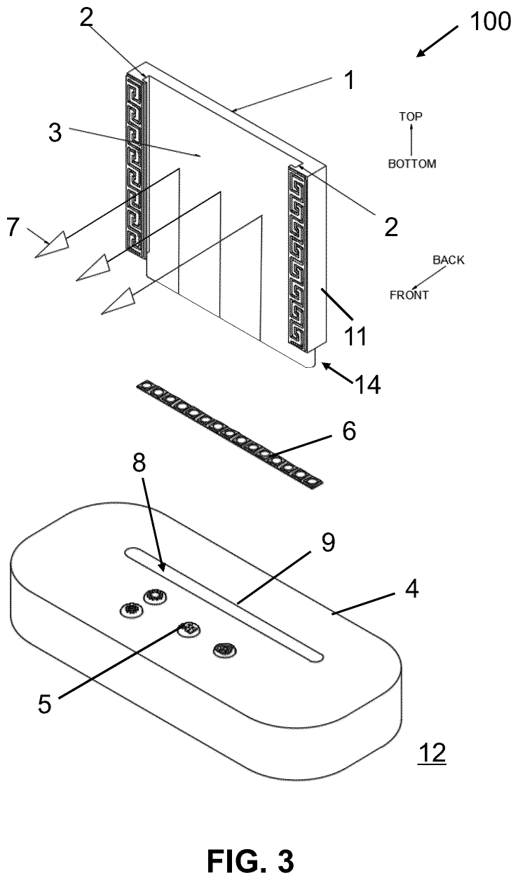

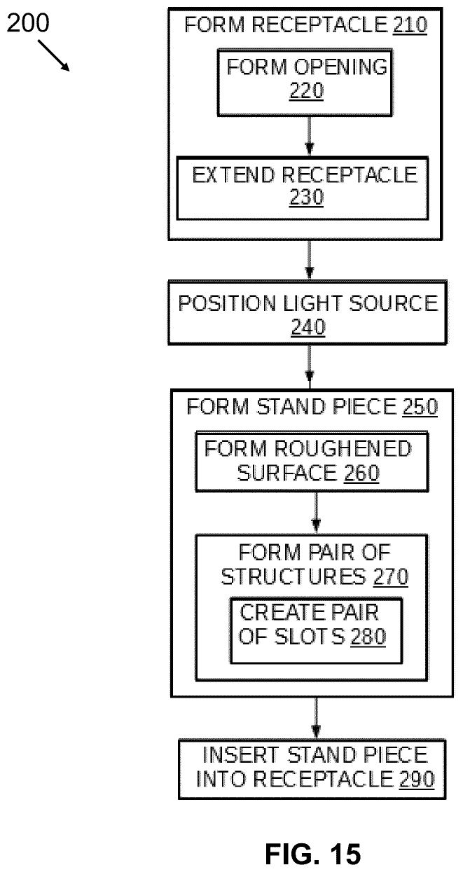

FIG. 2 is a perspective view of a display unit 100 for lithophanes 10 according to some embodiments of the present technology. FIG. 3 is an exploded view in perspective of the display unit 100 shown in FIG. 2. Display unit 100 may include a multi-functional stand piece 1 and a base 4. Stand piece 1 may include a front side and a back side, as denoted in FIGS. 1 and 2. Stand piece 1 may be at least partially clear or translucent. A front side of stand piece 1 may have a roughened surface 3. The roughened surface 3 may extend from a top to a bottom of stand piece 1. The front surface of the stand piece 1, including the roughened surface 3 may be fabricated or otherwise formed to have a slight backward angle (e.g., 1-2 degrees). Such examples may have the aforementioned backward angle formed at a range of from greater than 0 degrees to less than or equal to 5 degrees, as further described below with reference to FIG. 14.

Opposing sides of stand piece 1 may include structures 11 attached to or formed on stand piece 1 that are sufficient to create slots 2 that face each other, as shown in FIGS. 2 and 3. At least a portion of front, back and/or side-facing surfaces of the aforementioned structures 11 may be well suited for inclusion of aesthetic design elements, such as are shown in FIGS. 2 and 3. In an example, stand piece 1 may be made as a one-piece 3D printed part. In other examples, stand piece 1 may be injection (or other type of) molded, cast or extruded. In yet other examples, stand piece 1 may be made of a solid piece of plexiglass or glass, and the roughened surface 3 may be engraved onto the front side of stand piece 1 using a laser or diamond bit. In the case of stand piece 1 formed at least in part from a clear glass material, roughened surface 3 may be provided thereon by sandblasting, or chemical (e.g., acid) etching. In any event, a material of construction of at least the portion of stand piece 1 having the roughened surface 3 on its front side, and likewise that portion extending therefrom to the back side, is formed of a clear, or at least translucent, material of construction (e.g., plastic or glass, for example).

Base 4 of display unit 100 may have an at least partially hollow interior cavity inside of which may be various electrical and/or electronic components, at least one of which may be operably coupled to one or more buttons 5, as will be described in greater detail below. As will be appreciated by persons having ordinary skill in the art, a shape of the base 4 need not be of the shape depicted in the example embodiment shown in FIGS. 2 and 3, but rather may be any suitable shape that may enable the base 4 to stably support a weight of the multi-functional stand piece 1. As but one example, a bottom of the base 4 may be flat so as to remain stable when it is placed on a flat surface 12. In another example, several pads may be placed on the bottom side of the base 4 to enable it to remain stable when placed on a substantially flat surface.

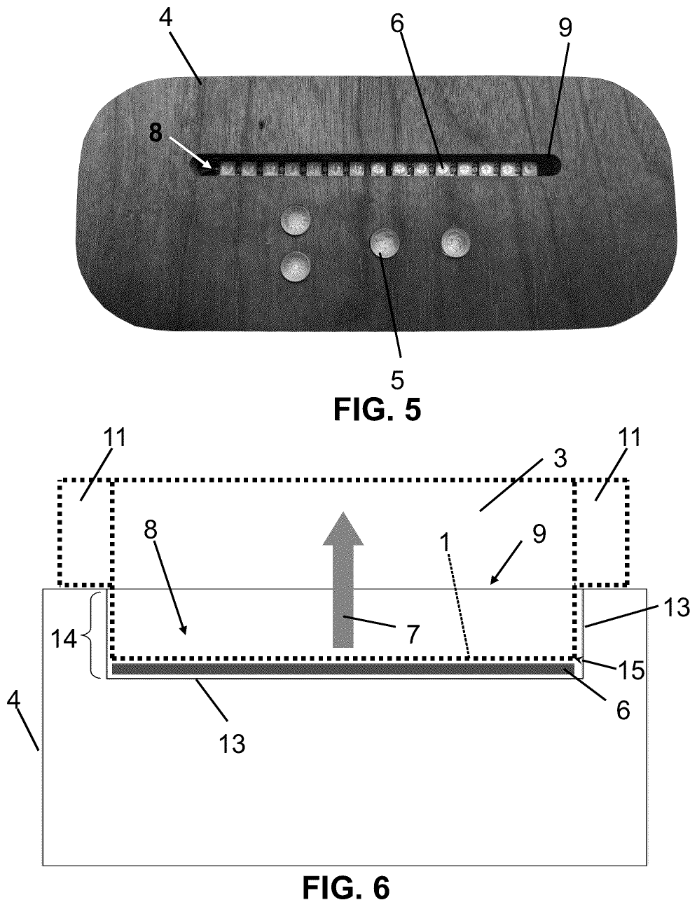

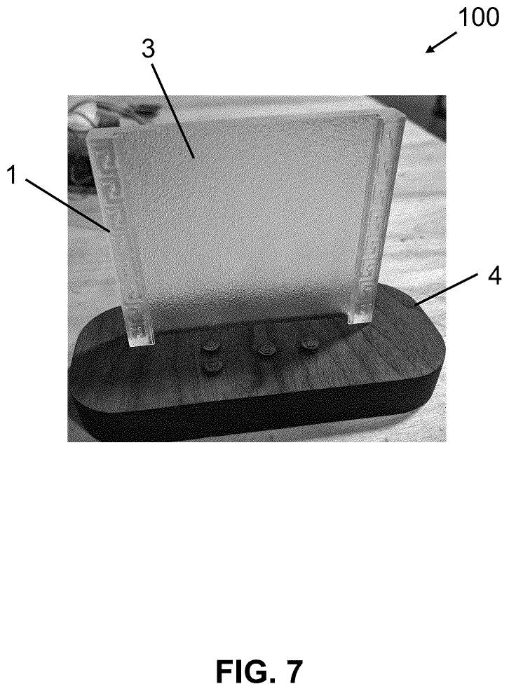

A top of base 4 may include an opening 9 that provides access to at least a portion of the aforementioned interior cavity. In an example, the opening 9 forms a receptacle 8 of the base 4 that extends from a top surface of the base 4 downward into a portion of base 4. FIG. 5 is a top view of a base of a display unit 100 for lithophanes 10 according to some embodiments of the present technology. FIG. 6 is a side view of a portion of a receptacle 8 of a base 4 of a display unit 100 according to some embodiments of the present technology. With additional reference being made to FIGS. 2 and 3, display unit 100 may include an electric light source 6 operably coupled to means for providing an electric current to light source 6. Such means may include a power supply along with wiring and possibly other circuitry electrically coupled to light source 6. In an example, the power supply includes one or more batteries. They may be rechargeable batteries and, in some embodiments, recharging components may be disposed inside of the base 4 and electrically coupled to the rechargeable battery cell(s). In another example, the power supply may include electric circuitry components sufficient to enable a wired connection to a utility mains outlet of a house, for example, to be transformed into a direct current voltage sufficient to energize the light source 6 during operation of the display unit 100. Other examples may include a photovoltaic panel disposed on top and/or side surfaces of base 4 to provide charging current to the aforementioned rechargeable battery cell(s) and/or to directly power light source 6.

In some embodiments, a photoresistor or similar light sensitive and/or light activated switching device may be included in the aforementioned circuitry to enable automatic turning on and off of the light source 6 in response to a level of ambient light existing proximate to the display unit 100. For instance, when a level of natural daylight impinging on a back facing surface of stand piece 1 drops below an appropriate threshold level, a light sensitive switching device positioned at least in part on or in an exterior surface of display unit 100 may be activated to thereby turn on light source 6 such that a lithophane 10 may continue to be viewable to a user display unit 100.

In some embodiments, as shown, for example and without limitation, in FIGS. 5 and 6, light source 6 is embodied in a strip of a plurality of LED lamps having a side-to-side length and a front-to-back width that are at least roughly equal to (or just somewhat less than) the corresponding 2D dimensions of the opening 9, as shown in FIG. 5. Also, as shown in FIGS. 5 and 6, the light source 6 embodied in an LED strip may be positioned in base 4 so as to rest at a bottom of receptacle 8. In some embodiments, at least a portion of the base 4 is formed of an opaque material of construction. In an example, walls 13 and/or a bottom of receptacle are opaque so as to prevent a significant (e.g., at most only a nominal amount) of light from being directed in unwanted or not useful directions other than in a generally top-ward direction through the opening 9. The opening 9 may be formed so as to provide a tight fit with the inserted bottom of the multi-functional stand piece 1. The aforementioned tight fit may function to prevent, or at least mitigate, any light from light source 6 from leaking through the base 4 and undesirably shining onto a face of lithophane 10 during operation of the display unit 100 according to the present technology. Gluing or otherwise coupling the bottom of stand piece 1 to the base 4 may accomplish similar ends.

Referring again to FIGS. 2, 3 and 5, in some embodiments, the receptacle 8 and opening 9 may be shaped and dimensioned to securely, yet removably, receive the stand piece 1 and enable it to be free standing upright as so positioned. In other embodiments, the stand piece 1 may instead be securely coupled to the base 4. As shown in FIG. 6, when inserted into and received by receptacle 8 through the opening 9, a bottom of the stand piece 1 may be situated upon, or proximate to, a top-ward facing portion the light source 6. In an example, dimensions of an offset or space 14 (as shown in FIGS. 2, 3 and 6) between structures 11 and the bottom of the portion of stand piece 1 having roughened surface 3 may enable the bottom of structures 11 to rest on the top surface of base 4 to thereby determine the spacing 15 between the bottom of stand piece 1 and the top of the light source 6 (e.g., LED strip).

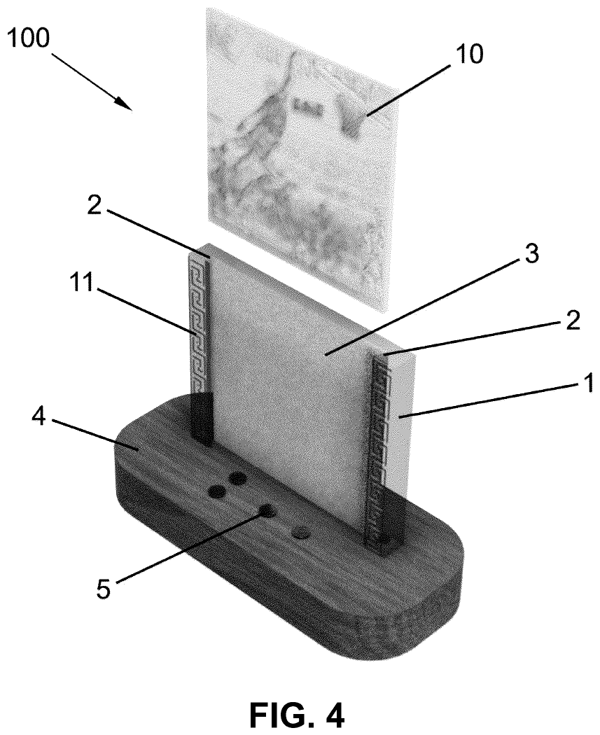

FIG. 4 is a perspective view of a display unit 100 for lithophanes 10 with a lithophane positioned for insertion into slots 2 according to some embodiments of the present technology. As shown in FIG. 4, and also in FIGS. 2 and 3, each slot 2 of the pair of opposing slots 2 extends from the top of a respective structure 11 of the pair of structures 11 to a bottom of the respective structure 11. In some embodiments, slots 2 may be shaped and dimensioned to enable lithophane 10 to be alternately inserted and removed from the multi-functional stand piece 1. As such, a user of the display unit 100 may conveniently view images present in a lithophane 10 without having to hold it or handle it at all. Furthermore, a user of display unit 100 is also able to conveniently switch out different lithophanes 10.

When inserted, one side of lithophane 10 may be positioned adjacent to the roughened surface 3 of stand piece 1. In an example, at least a portion of the lithophane 10 may be in contact with roughened surface 3 when inserted into slots 2 of stand piece 1. In another example, lithophane 10 may not contact roughened surface 3 when so inserted. In some embodiments, when lithophane 10 is inserted into the slots 2 of the stand piece 1, a bottom of lithophane 10 may rest on the top surface of base 4 (e.g., proximate the front side of opening 9).

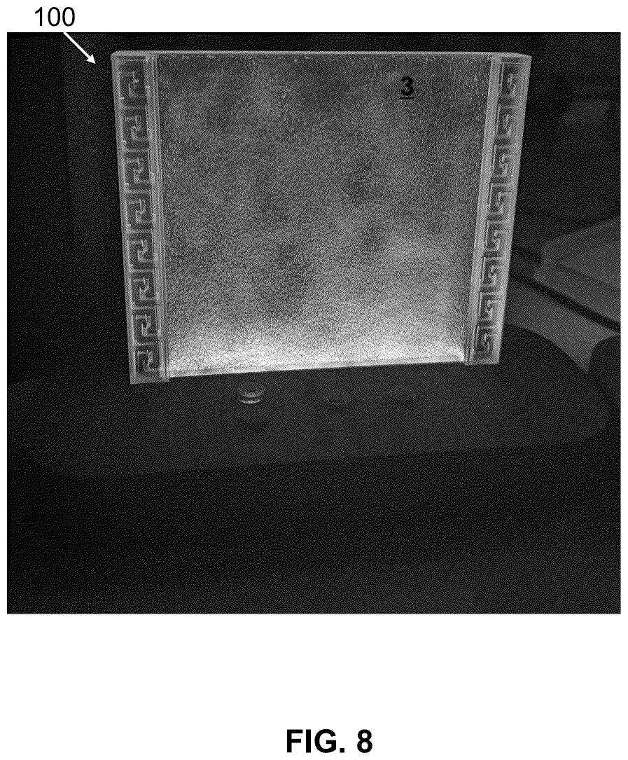

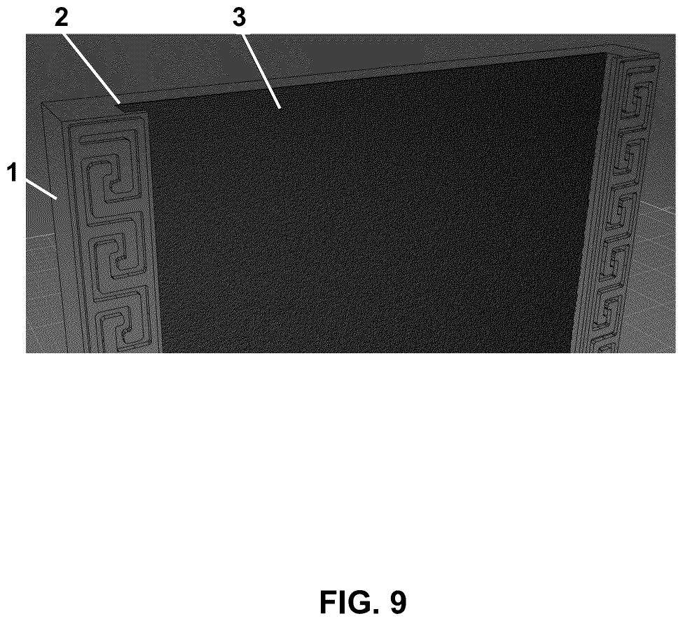

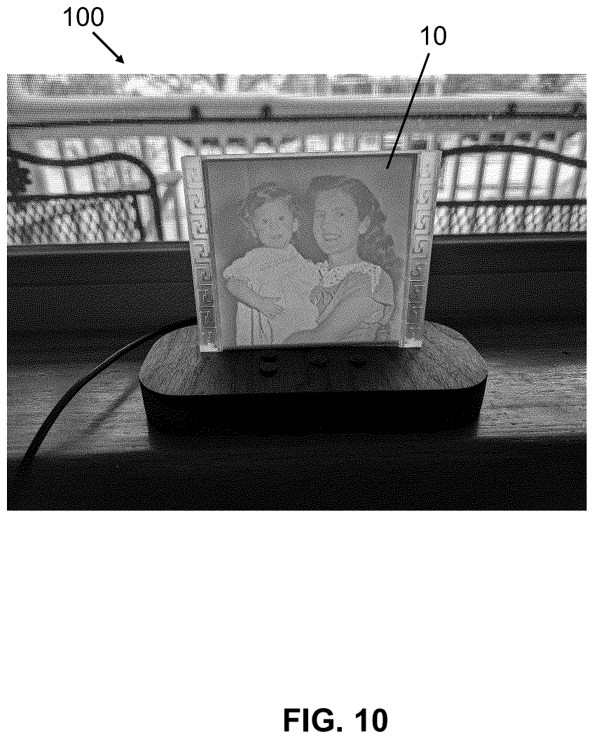

FIG. 7 is a perspective view of a display unit 100 for lithophanes 10 according to some embodiments of the present technology. FIG. 8 depicts the display unit 100 of FIG. 7 in a darkened room with a white light source 6 turned on without an inserted lithophane 10. FIG. 9 is a perspective view of a portion of a multi-functional stand piece 1 of a display unit 100 according to some embodiments of the present technology. FIGS. 7-9 depict additional views of the roughened surface 3 according to some embodiments of the present technology. In some embodiments, the portion of stand piece 1 having roughened surface 3 may have a surface area (e.g., 100 mm×100 mm) to match a length and width of a lithophane 10 to be viewed using the display unit 100 according to the present technology.

Referring also to FIGS. 3 and 6, with the bottom of multi-functional stand piece 1 inserted into receptacle 8 and positioned proximate to, or contacting, light source 6 (e.g., LED strip), light emitted therefrom (denoted as light path 7 in FIGS. 3 and 6) is transmitted into the material of construction of the stand piece 1 during operation of display unit 100 according to the present technology. Upon entering the material of stand piece 1, the light path 7 taken may be in a generally top-ward direction, as shown in FIGS. 3 and 6. A portion of the light will reach roughened surface 3 and upon that occurring, the light path 7 for that portion of the light will change direction, including changing direction from the aforementioned top-ward direction to a direction that is generally frontward facing (e.g., perpendicular to the frontward facing surface defined by offset 14 of stand piece 1, as shown, for example, in FIGS. 2 and 3). Upon changing its direction of travel in this manner and on account of the roughened surface 3, light path 7 may exit the material of construction of stand piece 1 through the roughened surface 3, as shown in FIG. 3. That portion of the light may thereby pass through a lithophane 10 positioned in slots 2 of the display unit 100 according to the present technology. As shown in FIG. 8, the function of light path 7 in the multi-functional stand piece 1 according to the present technology creates an area of bright light that may be at least approximately the same size as a lithophane to be inserted in front of the roughened surface 3 area by way of the slots 2.

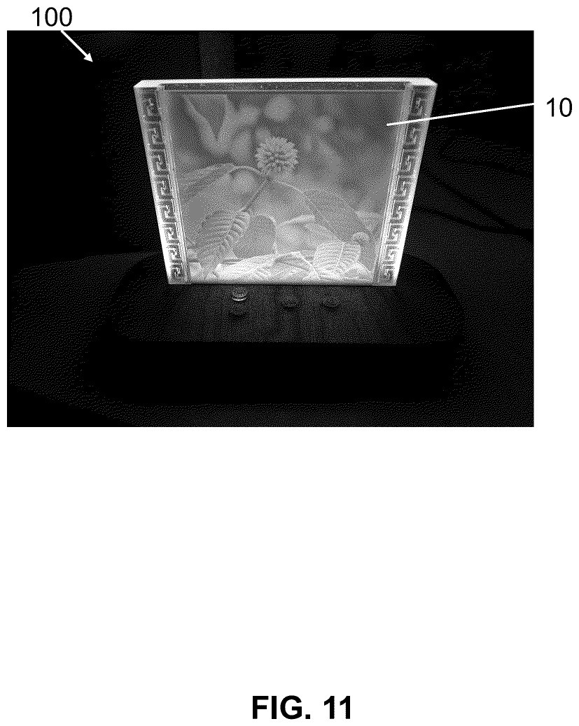

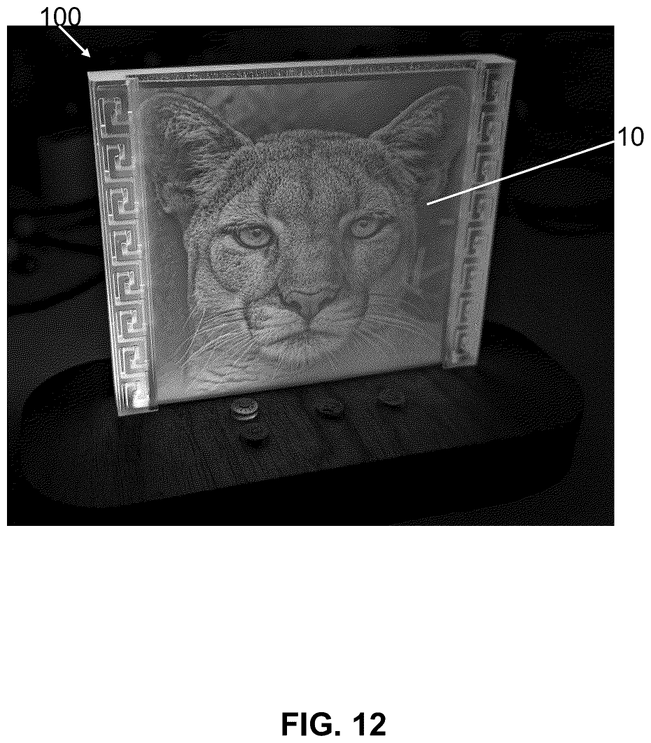

FIG. 11 depicts another lithophane 10 being backlit in a darkened room using a white light source 6 of a display unit 100 according to some embodiments of the present technology. With the light source 6 (e.g., white light LEDs arranged in a strip of LEDs, as described above above) energized and a lithophane 10 inserted into display unit via slots 2 in a darkened room, the above described change(s) in the direction of travel of light path 7 provided by the stand piece 1 with the roughened surface 3 thereby illuminates the lithophane 10 and enables the image present in the lithophane 10 to be viewed in the absence of daylight, or in a darkened room, as shown in FIG. 11. FIG. 10 depicts the lithophane 10 shown in FIG. 1 being backlit by natural daylight while positioned in a display unit 100 according to some embodiments of the present technology. Notably, the display unit 100 may be used to view an image present in a lithophane 10 using natural daylight backlighting and without having to turn on the light source 6, as shown in FIG. 10.

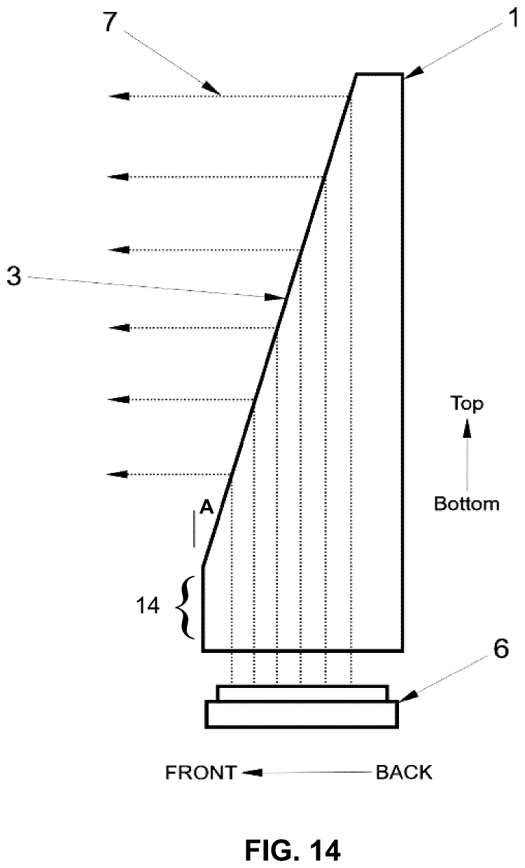

In some embodiments, the roughened surface 3 may be created by first preparing to make a 3D lithophane from an image of white noise 20 (e.g., as would be seen for static or noise of a black and white television, as shown in FIG. 13). Then, in a suitable computer-aided design (CAD) software application, an electronic file (e.g., a .stl file) containing data representative of a 3D model prepared for 3D printing of the lithophane 10 may be combined (e.g., placed onto) the front facing surface of a 3D model of the stand piece 1. Next, the stand piece 1 having the roughened surface 3 may be 3D printed (e.g., by an SLA-based technique) to thereby produce the multi-functional stand piece 1 for use in the display unit 100 according to the present technology. The resulting randomized 3D bump map for the roughened surface 3 of the front facing surface of stand piece 1 may, during operation of display unit 100, facilitate diffusing light of the light path 7 originating at light source 6 evenly onto the inserted lithophane 10, as well as optimize light brightness for displaying the image present in lithophane 10 at night or in a dark room. Furthermore, as described below with reference to FIG. 14, a slight angled (of from greater than 0 degrees to less than or equal to 5 degrees, e.g., 1-2 degrees) surface of the front face of stand piece 1, including the roughened surface 3, further enhances the even diffusion of light along the roughened surface 3 and inserted lithophane 10.

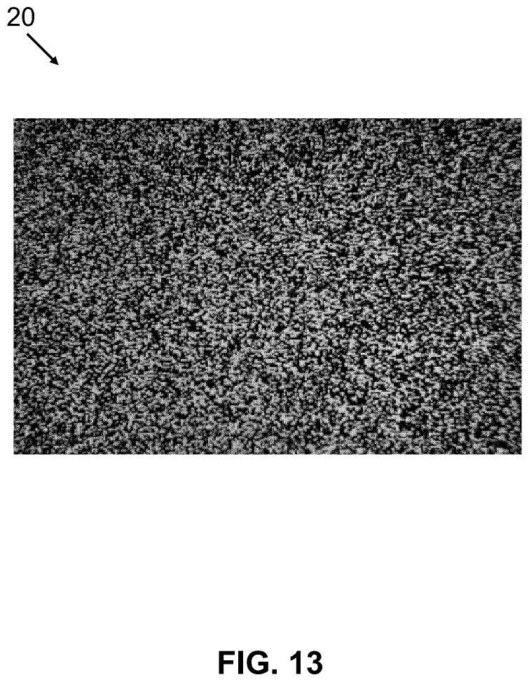

Referring back to FIGS. 2-5, in addition to a button 5 (or other switch) for turning light source 6 on and off, button(s) 5 accessible to the user of display unit 100 may include means for adjusting the brightness of the light source 6 for in the techniques according to the present technology. FIG. 12 depicts another lithophane 10 being backlit in a darkened room with a variable color light source of a display unit 100 according to some embodiments of the present technology. In examples where light source 6 is embodied in a plurality of LED lamps arranged laterally, one or more of the LEDs may have a different color when energized as compared to at least one other LED. In some embodiments, one or more of the plurality of LED lamps of light source 6 may be capable of being illuminated at two or more different colors depending on an applied electric current to them. In some embodiments, logic circuitry or other analog and/or digital electronic components may be present inside of base 4 and operably coupled to light source 6 embodied in a strip of a plurality of multi-color LEDs. In an example, a button 5 may be operably coupled to the aforementioned logic circuitry. Such a button 5 (or likewise a switch or a knob) may be accessible to the user of display unit 100 in order to activate an LED coloration or color change scheme to achieve an effect as shown in FIG. 12. In an example, such a button 5 may also enable switching the light source 6 from being white light to being colored light (or combinations of different colors). Individual LED lamps of a light source 6 embodied in an LED strip according to some embodiments of the present technology may be individually addressable to logic circuitry to achieve effects (which may be timed or choreographed) like flickering candle light, multi-color wipes, among a multitude of other possibilities.

As to the embodiments described above with reference to FIGS. 2-13, structure 11 and slots 2, and relatedly described features of display unit 100 may also be referred to herein as means for positioning lithophane 10 upon or proximate to the roughened surface 3 of stand piece 1.

In some embodiments, turning light source on and off, and/or controlling brightness, color, and/or changing of lighting effects, may be accomplished wirelessly by way of, for example, a WiFi or Bluetooth communications protocol. In an example, a user of display unit 100 may have an app installed on a smartphone and display unit 100 may include a suitable radio frequency (RF) receiver to receive signals from the smartphone to control any of the above described operations involving light source 6. These aspects according to the present technology may be applied in like manner to embodiments of display units 300 and 400, as described below with reference to FIGS. 14-29.

FIG. 14 is a side sectional view of the stand piece 1 depicting an angled front roughened surface 3 for use in a display unit 100 according to some embodiments of the present technology. Features described above with reference to FIG. 2 are also shown in FIG. 14 for context. The sectional view of FIG. 14 is taken in the middle of the stand piece 1 of FIG. 2 from top to bottom and, as such, slots 2 are not depicted. Note that the angle is largely exaggerated to illustrate the light rays from light path 7 being more evenly distributed as they exit the roughened surface 3 of stand piece 1. In some embodiments, the front of the stand piece 1 including roughened surface 3 may be angled slightly (e.g., 1-2 degrees, exaggerated and not shown to scale in FIG. 14) backwards (from front to back), giving the roughened surface 3 a subtle slope from the bottom to the top of at least a portion of the stand piece 1 and towards the back of the display unit 100. This angle is denoted “A” in FIG. 14. In some embodiments, angle “A” may range from greater than 0 degrees to less than or equal to 5 degrees. The aforementioned slight angle may allow the initially upwardly shining light path 7 provided by light source 6 to more evenly distribute along the roughened surface 3 where the light of light path 7 may then exit the front roughened surface 3 of the stand piece 1, where it may then shine through a positioned lithophane 10. As such, the above described slightly angled surface feature according to the present technology may provide a more uniform diffusion of light brightness behind the lithophane 10, ensuring a more evenly lit from top to bottom 3D image.

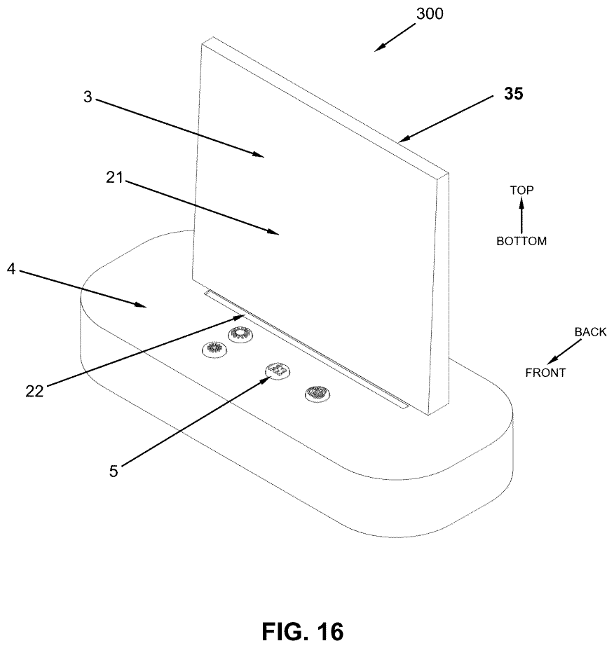

FIG. 15 is a flow chart of a method 200 of manufacturing a display unit 100 for lithophanes 10 according to some embodiments of the present technology. Further reference is made to features described in FIGS. 2-6 and the foregoing figures. The method 200 may include the step of forming 210 a receptacle 8 in a portion of a base 4 of the display unit 100. In some embodiments, forming 210 the receptacle 8 may include the steps of: forming 220 an opening 9 in a portion of a top surface of the base 4; and extending 230 the receptacle 8 downward from the opening 9 into a portion of the base 4. Method 200 may include the step of positioning 240 a light source 6 at or proximal to a bottom of the receptacle 8. Method 200 may include the step of forming 250 a stand piece 1 having a top and a bottom, and with the bottom of the stand piece 1 being configured (e.g., formed to have dimensions enabling it) to be inserted into the receptacle 8.

In some embodiments, the method 200 step of forming 250 the stand piece 1 may include the steps of: forming 260 a roughened surface 3 on at least a portion of a front side of the stand piece 1; and forming 270 a pair of structures 11 disposed on opposing sides of the stand piece 1 and extending from a top of the stand piece 1 to or proximate to the bottom of the stand piece 1. In an example, forming 270 the pair of structures 11 may include creating 280 a pair of slots 2 extending from tops of the structures 11 to bottoms of the structures 11, the slots 2 being configured to receive opposing sides of a lithophane 10. In some embodiments, the method 200 step of forming 250 the stand piece 1 may include forming the stand piece 1 to include an angled section including the roughened surface 3. With reference to FIG. 14, stand piece 1 may be formed to have a backward angle (denoted “A” in FIG. 14), where A may be greater than 0 degrees and less than or equal to 5 degrees. In an example, angle A is from 1 degree to 2 degrees. In another example, angle A is greater than 1 degree and less than 2 degrees. In embodiments where the method 200 step of forming 250 the stand piece 1 includes forming the stand piece 1 to include the above described angled section, the method 200 may also include forming the stand piece 1 to have a non-angled (e.g., straight or 0 degrees—that is, normal to a top surface of base 4, as shown in FIG. 3) portion (e.g., labeled 14 in FIGS. 2 and 14) to provide the above described offset or space 14. In an example, the aforementioned non-angled portion may be positioned at a bottom of stand piece 1 and may have a height that is approximately equal to a depth from the top of receptacle 8 (e.g., at opening 9) corresponding to a top of base 4 and the top of light source 6 positioned at a bottom of receptacle 8. In an example, the aforementioned height of the non-angled portion at the bottom of stand piece 1 may be somewhat less than the aforementioned depth to thereby provide any desired spacing 15. As shown in FIG. 14, the non-angled portion may be formed in method 200 beneath the angled portion of stand piece 1 and it may have a height that is largely less than a height of the angled portion. In some embodiments, all of the various portions of stand piece 1 described herein (e.g., roughened surface 3, structures 11, slots 2, angled portion, and non-angled portion) may be formed from, and of, one piece and all such structures may thereby be continuous with respect to one another.

In one example, the receptacle 8 may be formed 210 in method 200 before the stand piece 1 is formed 250. In another example, the stand piece 1 may be formed 250 before the receptacle 8 is formed 210 in method 200. In yet another example, the receptacle 8 may be formed 210 concurrently with the stand piece 1 being formed 250 in method 200. In some embodiments, method 200 may also include the step of inserting 290 the bottom of the stand piece 1 into the receptacle 8 to bring the bottom of the stand piece 1 in contact with or in proximity to the light source 6.

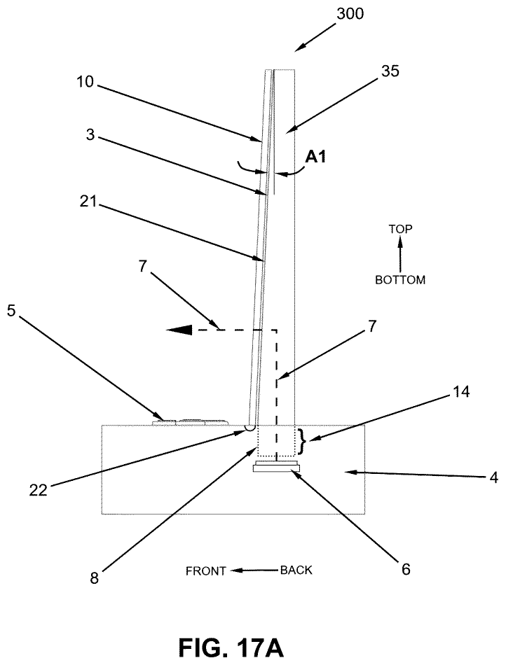

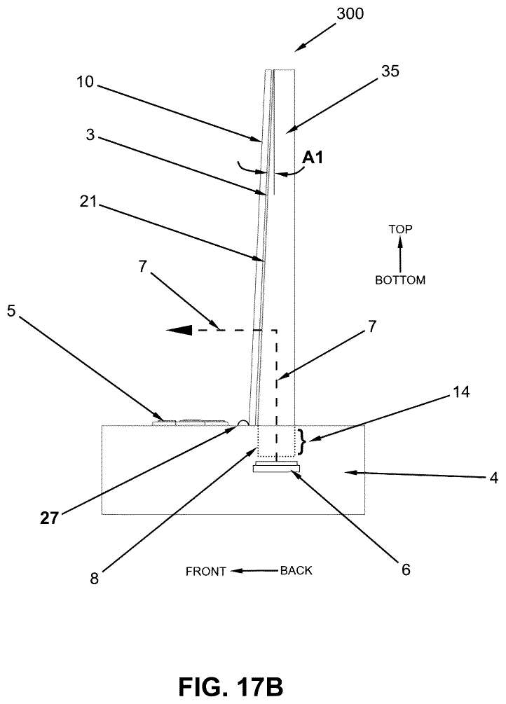

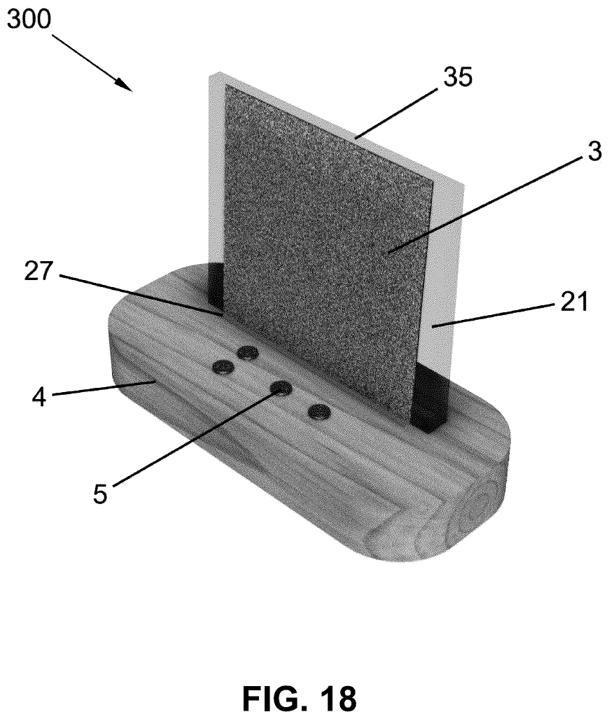

FIG. 16 is a perspective view of a display unit 300 for lithophanes 10 according to other embodiments of the present technology. FIGS. 17A and 17B are side views of the display unit 300 for lithophanes 10 shown in FIG. 16 according to some embodiments of the present technology. FIG. 18 is a perspective view rendering of the display unit 300 shown in FIG. 17B. Features of display unit 300 that are in common with those described above with reference to display unit 100 are also shown in FIGS. 17, 17A, 17B and 18 for context. As compared to display unit 100 as described above with reference to the foregoing figures, rather than a stand piece 1 having slots 2 to receive opposing sides of lithophane 10, display unit 300 may include stand piece 35 having a slanted face 21 and without any slots for lithophanes 10. An angle “A1” at which the aforementioned slanted face 21 slants with respect to a vertical front surface of offset 14 (as shown in FIGS. 17A and 17B) may be any of the values (or ranges of values) for “A” as described above with reference to FIG. 14.

Further in contrast to display unit 100, display unit 300 does not include structures 11 and opposing slots 2 for receiving lithophanes 10 and holding them in place, as in stand piece 1. Instead, examples of display unit 300 illustrated in FIGS. 16 and 17A may utilize a stand piece 35 with slanted front face 21 and a groove 22 formed on or in a top surface of base 4. In this embodiment, the lithophane 10 may be held in place by gravity with the slanted front face 21 allowing the lithophane 10 to rest in position (e.g., with the bottom edge of lithophane 10 at least partly in groove 22). The groove 22 in the base 4 may be positioned just in front of stand piece 35 to thereby prevent the bottom of lithophane 10 from slipping forward, thus enabling lithophane 10 to remain properly positioned in front of the roughened surface 3 of stand piece 35 for back illumination by light path 7. For instance, a spacing between the back edge of groove 22 and a front edge of opening 9 defining the top of receptacle 8 may be approximately equal to a thickness of the bottom of lithophane 10, while a left-to-right length of groove 22 may be just slightly greater (e.g., 1-2 millimeters) than a left-to-right length of the bottom of lithophane 10.

Examples of display unit 300 illustrated in FIGS. 17B and 18 may utilize the stand piece 35 with slanted front face 21 and a ridge 27 formed on, and extending upward from, the top surface of base 4. In this embodiment, the lithophane 10 may be held in place by gravity (and possibly also friction) upon the topward-facing surface of base 4 and the frontward-facing surface of the slanted front face 21 to thereby enable the lithophane 10 to rest in position (e.g., with the bottom edge of lithophane 10 at least partly abutting ridge 27). The ridge 27 on the base 4 may be positioned just in front of stand piece 35 to thereby prevent the bottom of lithophane 10 from slipping forward, thus enabling lithophane 10 to remain properly positioned in front of the roughened surface 3 of stand piece 35 for back illumination by light path 7. For instance, a spacing between the back edge of ridge 27 and a front edge of opening 9 defining the top of receptacle 8 may be approximately equal to a thickness of the bottom of lithophane 10. In an example, a left-to-right length of ridge 27 may be just slightly greater (e.g., 1-2 millimeters) than a left-to-right length of the bottom of lithophane 10. In another example, a left-to-right length of ridge 27 may be just slightly less (e.g., 1-2 millimeters (mm)) than a left-to-right length of the bottom of lithophane 10. In yet another example, a left-to-right length of ridge 27 may be substantially less than a left-to-right length of the bottom of lithophane 10 (e.g., between 75% to 10% of the left-to-right length of the bottom of lithophane 10), and with ridge 27 generally centered in front of the aforementioned front edge of opening 9. In some embodiments, a plurality of ridge 27 structures may be dispersed and spaced in front of opening 9, where, for example and without limitation, each instance of ridge 27 in that case has a left-to-right length that is less than half the left-to-right length of the bottom of lithophane 10.

Roughened surface 3 may be formed on at least a part of the frontward facing slanted face 21 of stand piece 35 in like or analogous manner as described above for stand piece 1 of display unit 100 and method 200. Placing a lithophane 10 onto the display unit 300 for viewing may thus be an easy process of placing the bottom of the lithophane 10 into groove 22, or to abut ridge 27, to thereby enable back side of lithophane 10 to rest on the slanted face 21.

In an analogous fashion as for stand piece 1 of display unit 100 as described above with reference to FIGS. 3 and 6, with the bottom of stand piece 35 (including offset 14) inserted into receptacle 8 and positioned proximate to, or contacting, light source 6 (e.g., LED strip), light emitted therefrom (as light path 7 in FIGS. 17A and 17B) is transmitted into the material of construction of the stand piece 35 during operation of display unit 300 according to the present technology. Upon entering the material of stand piece 35, the direction of light path 7 may be generally top-ward, as shown in FIGS. 17A and 17B. At least a portion of the light will reach roughened surface 3 and upon that occurring, the light path 7 for that portion of the light will change direction, including changing direction from the aforementioned top-ward direction to a direction that is generally frontward facing (e.g., perpendicular to the frontward facing surface defined by offset 14 of stand piece 35, as shown, for example, in FIGS. 17A and 17B).

Upon changing its direction of travel in this manner and on account of the roughened surface 3, light path 7 may exit the material of construction of stand piece 35 through the roughened surface 3 of slanted face 21, as shown in FIGS. 17A and 17B. That portion of the light may thereby pass through a lithophane 10 positioned in groove 22, or to abut ridge 27, and resting upon slanted face 21 of the display unit 300 according to the present technology. As in the case shown in FIG. 8 for display unit 100, the function of light path 7 in stand piece 35 according to the present technology creates an area of bright light that may be at least approximately the same size as a lithophane to be inserted into groove 22 or placed to abut ridge 27 to thereby rest upon the roughened surface 3 area of slanted face 21.

As to the embodiments described above with reference to FIGS. 16-18, slanted face 21 of stand piece 35, groove 22, and ridge 27, and relatedly described features of display unit 300 may also be referred to herein as means for positioning lithophane 10 upon or proximate to the roughened surface 3 of stand piece 35.

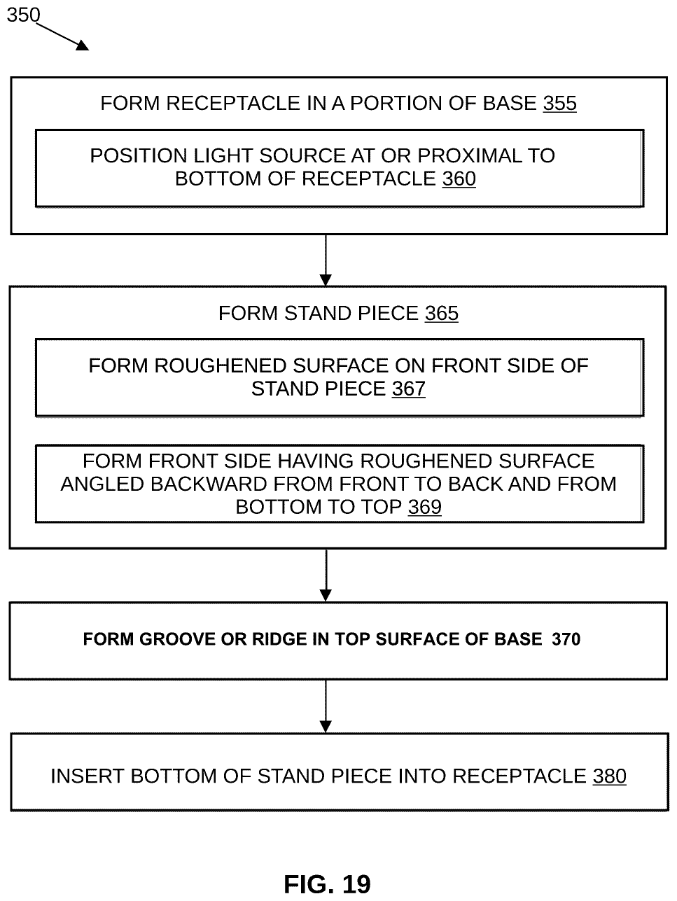

FIG. 19 is a flow chart of a method 350 of manufacturing a display unit for lithophanes (e.g., display unit 300) according to other embodiments of the present technology. Method 350 may include the step of forming 355 a receptacle (e.g., 8) in a portion of a base (e.g., 4) of the display unit (e.g., 300). In some embodiments, the forming 355 step of method 350 may include forming an opening (e.g., 9) in a portion of the top surface of the base. Forming 355 the receptacle in method 350 may also include extending the receptacle downward from the opening into a portion of the base. Method 350 may include the step of positioning 360 a light source (e.g., 6) at or proximal to a bottom of the receptacle.

Method 350 may include the step of forming 365 a stand piece (e.g., 35) having a top and a bottom. In some embodiments, the stand piece may be formed 365 in method 350 such the that the bottom of the resultant stand piece 35 is configured (e.g., formed to have dimensions enabling it) to be insertable into the receptacle 8. In an example, the method 350 step of forming 365 the stand piece 35 may include forming 367 a roughened surface (e.g., 3) on at least a portion of a front side of the stand piece 35. In another example, forming 365 the stand piece in method 350 may include forming the stand piece 35 of a clear or translucent material of construction. In yet another example, the method 350 step of forming 365 the stand piece 35 may include forming 369 the front side of the stand piece 35 including the roughened surface 3 to be angled backward from front to back and from the bottom to the top, as shown in FIGS. 17A and 17B.

Method 350 may include the step of forming 370 a groove 22 (or ridge 27) in or on the top surface of the base 4, as shown in FIGS. 16, 17A, 17B, amd 18. Forming 370 the groove 22 or ridge 27 in method 350 may include forming the groove 22 (or ridge 27) to be shaped, dimensioned, and positioned with respect to the opening 9 of the base 4 sufficiently to receive a bottom side of a lithophane (e.g., 10) and enable the lithophane 10 to remain stably positioned in front of the roughened surface 3 of the stand piece 35 when the bottom of the stand piece 35 is inserted into the receptacle 8. In one embodiment, method 350 may further include the step of inserting 380 the bottom of the stand piece 35 into the receptacle 8 to bring the bottom of the stand piece 35 in contact with or in proximity to the light source 6.

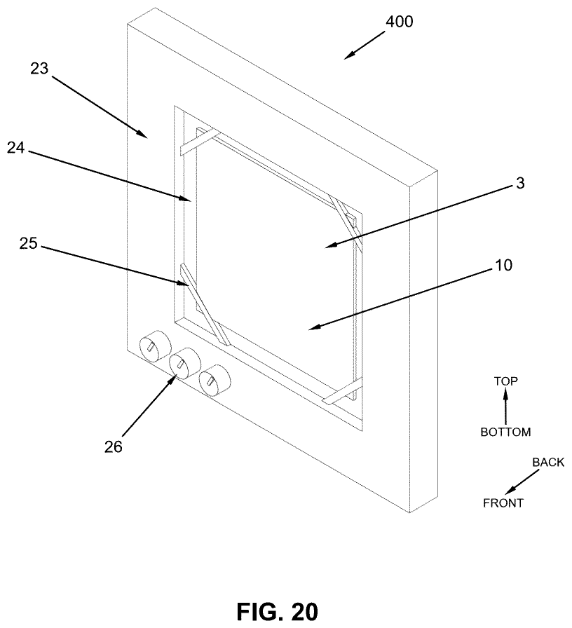

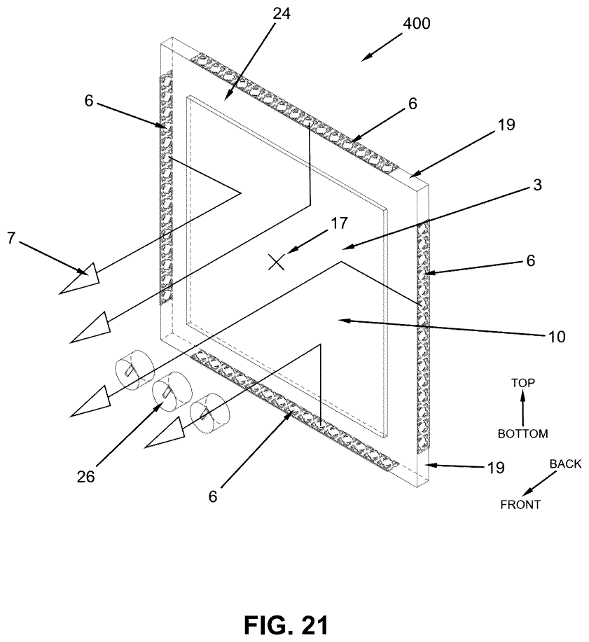

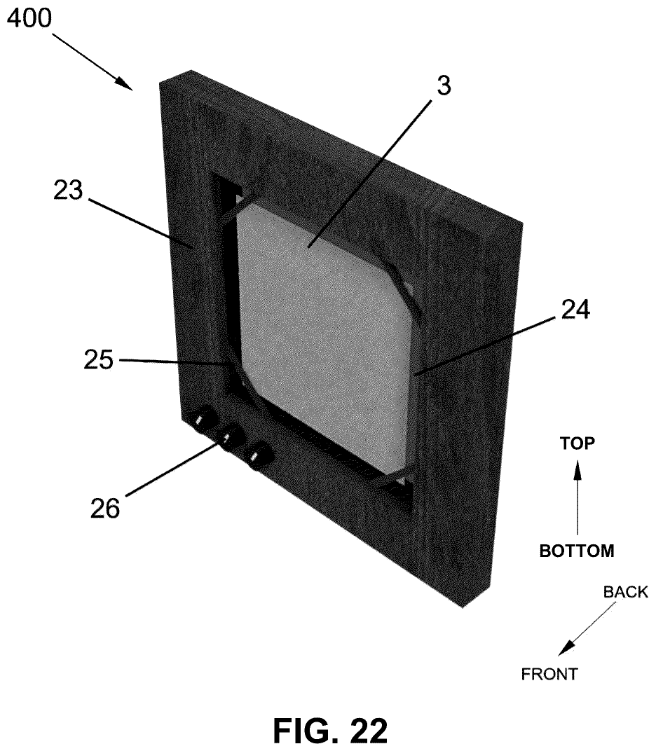

FIG. 20 is a perspective view of a display unit 400 (with frame 23 attached) for lithophanes according to some additional embodiments of the present technology. FIG. 21 is exploded view (with frame 23 removed) in perspective of the display unit 400 shown in FIG. 20. FIG. 22 is a perspective view rendering of the display unit 400 (with frame 23 attached) shown in FIG. 20. Features described above with reference to the foregoing figures are also shown in FIGS. 20-22 for context. Display unit 400 may include a frame 23 surrounding a pane 24 of clear or translucent material. In some examples, frame 23 may be made of an opaque material such as wood, colored plastic, or metal. Pane 24 may include the above-described roughened surface 3 formed on at least a portion of a frontward facing of the pane 24. In an example, pane 24 may be made as a one-piece 3D printed part to thereby provide the roughened surface 3 on at least a portion of the frontward facing surface of pane 24, in like or analogous manner as described above for display unit 100 and method 200. In other examples, pane 24 may be injection (or other type of) molded, cast or extruded. In yet other examples, pane 24 may be made of a solid piece of plexiglass or glass, and the roughened surface 3 may be engraved or otherwise formed onto the front side of pane 24 using a laser or diamond bit. In the case of pane 24 formed at least in part from a clear glass material, roughened surface 3 may be provided thereon by sandblasting, or chemical (e.g., acid) etching. In any event, a material of construction of at least the portion of pane 24 having the roughened surface 3 on its front side, and likewise that portion extending therefrom to the back side, may be formed of a clear, or at least translucent, material of construction (e.g., clear resin, plastic or glass, for example).

In some embodiments, as shown, for example and without limitation, in FIGS. 20 and 22, display unit 400 may include elastic cloth or rubber bands 25 positioned diagonally in all four corners of the frame 23 and directly in front of pane 24. The bands 25 can function to hold a lithophane 10 in place directly in front of, and potentially also contacting, roughened surface 3. In other embodiments, the bands may be made of other material, or an entirely different mechanism all together may be utilized such as magnets or clips to keep the lithophane positioned in front of roughened surface 3. Bands 25, magnets, clips, and such other functionally analogous structures and techniques may be referred to herein as means for positioning lithophane 10 upon or proximate to the roughened surface 3 of pane 24. In one example, such means may be disposed on at least a portion of pane 24 (e.g., on or near each corner of four corners of a square or rectangularly shaped pane 24). In another example, such means may be disposed on or in at least a portion of frame 23 (e.g., on or near each interior corner of four interior corners—e.g., of the frame 23 opening through which lithophane 10 may be viewed—of a square or rectangularly shaped frame 23 opening). In yet another example, such means may be on at least a portion of pane 24 as well on at least a portion of frame 23. A person of ordinary skill in the art may be expected to recognize and appreciate such alternatives to use of elastic bands 25 and the like for this functional purpose without departing from the scope and spirit of the present disclosure. In one embodiment, frame 23 of display unit 400 may have an at least partially hollow interior cavity inside of it which may house various electrical and/or electronic components, at least one of which may be operably coupled to one or more dials (or knobs) 26 (and/or buttons 5) accessible from an exterior of frame 23 by a user during operation of display unit 400.

When natural light is available, display unit 400 may be hung or otherwise positioned in a window or positioned such that sunlight may shine through the back of the clear or translucent pane 24. A lithophane 10, held in place by elastic bands 25 (e.g., as shown in FIGS. 20 and 22) or other means for positioning lithophane 10 upon or proximate to the roughened surface 3 of pane 24, may thus be backlit and viewed during the day with natural sunlight.

The same aforementioned power supply variations and electronic components utilized in display units 100 and 300 may be also used in display unit 400 to power and control at least one light source 6. As shown in FIG. 21 (pane 24 without frame 23), the light source(s) 6 of display unit 400 may be embodied as a plurality of LED lamps positioned side-to-side in an elongate strip. Display unit 400 may contain such LED strip(s), positioned such that they emit light directly into the edge(s) 19 of pane 24. In an example, as shown in FIG. 21, for a pane 24 of display unit 400 having four straight sides, one light source 6 strip with multiple LED lamps may be positioned on each side (e.g., edge 19) of pane 24 (i.e., for a total of four such strips). In another example, for such a square or rectangular pane 24, one to three sides (e.g., edge(s) 19) of pane 24 may include such a light source 6 LED strip.

Still referring to FIG. 21, as is the case in the stand piece 1 of display unit 100 and stand piece 35 of display unit 300, light path 7 from energized light source(s) 6 may be transmitted into the clear, transparent or translucent material of construction of the pane 24 during operation of display unit 400 according to the present technology. Upon entering the material of pane 24 from one, two, three or all four edges 19, the light path 7 may propagate toward the center 17 of the pane 24. A portion of that light may reach roughened surface 3 and upon that occurring, the light path 7 for that portion of the light may change direction, including changing direction from the aforementioned center 17-ward direction to a direction that is generally frontward facing (e.g., perpendicular to the frontward facing, non-slanted, surface of pane 24, as shown in FIG. 21). Upon changing its direction of travel in this manner and on account of the roughened surface 3, light path 7 may exit the material of construction of pane 24 through the roughened surface 3, as shown in FIG. 21, thereby enabling the light to pass through a lithophane 10 position on or proximate to the roughened surface 3. That portion of the light from light path(s) 7 may thereby pass through a lithophane 10 held in place by diagonal bands 25 (or other means for positioning lithophane 10 upon or proximate to the roughened surface 3 of pane 24) of the display unit 400 according to the present technology. As shown in FIG. 21, the function of light path(s) 7 in the pane 24 according to the present technology creates an area of bright light that may be at least approximately the same size as a lithophane 10 to be held in place in front of the roughened surface 3 area by way of the diagonal bands 25 (or other means for positioning lithophane 10 upon or proximate to the roughened surface 3 of pane 24). This roughened area 3 of bright light backlights and illuminates the lithophane 10 for viewing at night or in a darkened room.

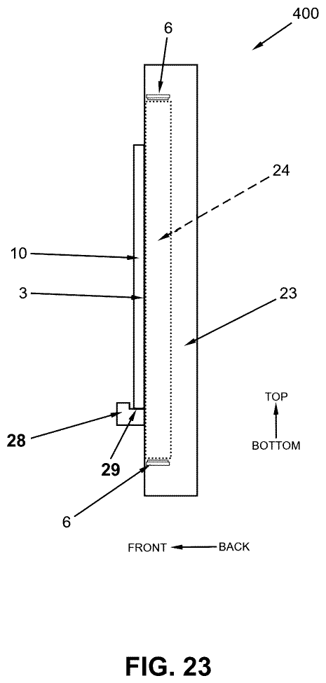

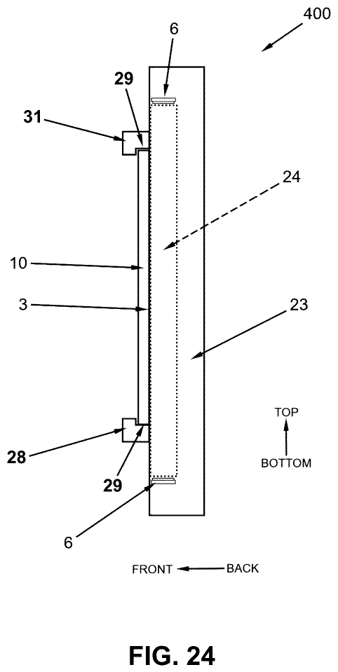

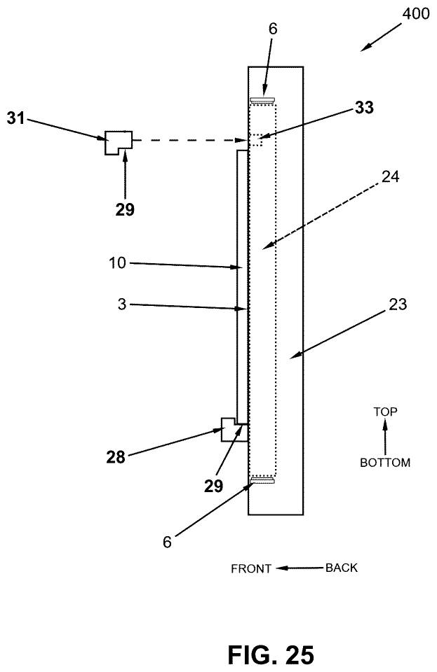

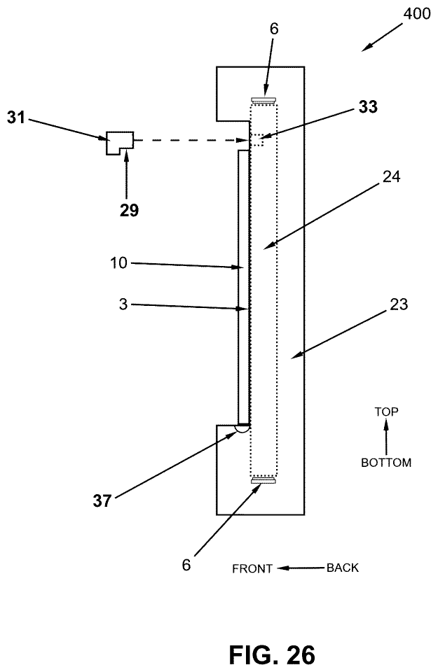

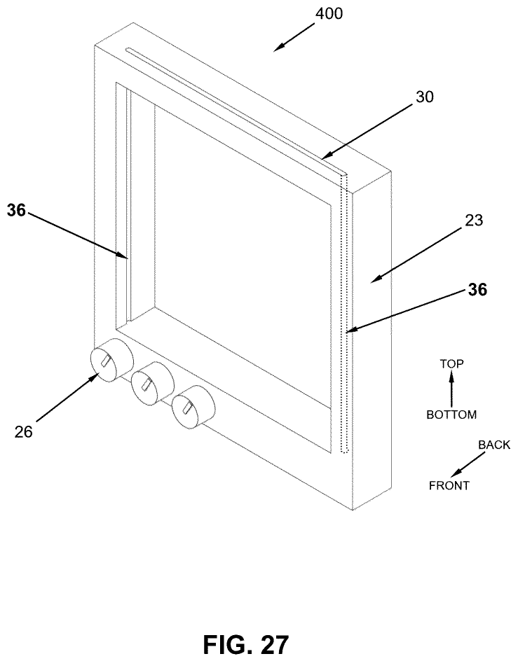

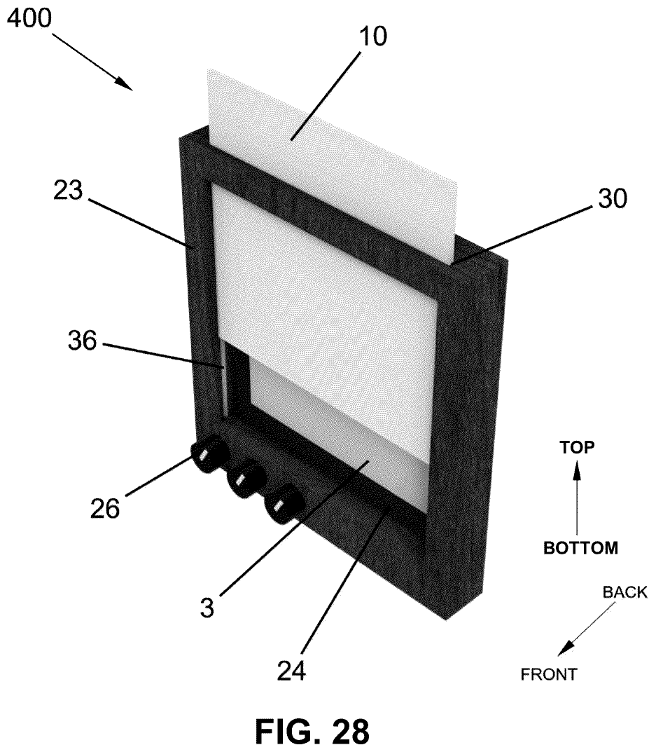

FIGS. 23-28 depict various embodiments of the pane 24 and the frame 23 that may be utilized in display unit 400 according to the present technology. FIG. 23 is a side view of the display unit 400 shown in FIG. 22 according to one embodiment of the present technology. FIG. 24 is a side view of the display unit 400 shown in FIG. 22 according to another embodiment of the present technology. FIG. 25 is a side view of the display unit 400 shown in FIG. 22 according to yet another embodiment of the present technology. FIG. 26 is a side view of the display unit 400 shown in FIG. 18 according to still another embodiment of the present technology. FIG. 27 is a perspective view of a framed display unit 400 for lithophanes 10 according to some embodiments of the present technology. FIG. 28 is a perspective view rendering of the display unit 400 shown in FIG. 27. Features described above with reference to FIGS. 20-22 are also shown in FIGS. 23-28 for context.

Notably, in the embodiments of display unit 400 illustrated in FIGS. 23-26, the frontward-facing surface of pane 24 need not be slanted at an angle as described above with respect to display units 100 and 200. However, it is to be emphasized that embodiments of display unit 400 illustrated in FIGS. 23-26 may have a pane 24 with a frontward-facing surface including roughened surface 3 that is angled (e.g., at any of the angles A and/or A1 as described above for display units 100 and 200) with respect to a vertical axis (e.g., as defined by a frontward-facing surface of frame 23). Conversely, it is additionally to be emphasized that embodiments of display unit 100 and 200 described with reference to the foregoing figures may have a stand piece (1 or 35) with a frontward-facing surface including roughened surface 3 that is not angled with respect to a vertical axis (e.g., as defined by a frontward-facing surface of offset 14).

In the examples shown in FIGS. 23-25, in particular, pane 24 may fit into the frame 23 opening such that a frontward-facing surface of pane 24 is flush with a frontward-facing surface of frame 23. Referring now to FIG. 23, pane 24 of display unit 400 may be placed into a suitably dimensioned and configured frontward-facing opening of frame 23. In the illustrated example, pane 24 may included, or may be configured to receive onto a portion of its frontward-facing surface, a structure 28. Structure 28 may have a lip-like structure in cross-section, and it may be either permanently coupled, or removably coupled, to a portion of the frontward-facing surface of pane 24 proximate to the bottom side of pane 24, such that structure 28 extends left-to-right. A left-to-right length of structure 28 may have a value sufficient to stably support a weight of lithophane 10. In an example, the left-to-right length of of structure 28 may be approximately equal to a length of the bottom side of lithophane 10. In other examples, the left-to-right length of of structure 28 may be greater than, or it may be less than, the length of the bottom side of lithophane 10. In some embodiments, a plurality of structures 28 may be dispersed and spaced from left-to-right along the portion of the frontward-facing surface of pane 24 proximate to the bottom side of pane 24, where, for example and without limitation, each instance of structure 28 in that case has a left-to-right length that is less than half the left-to-right length of the bottom of lithophane 10.

Structure 28 may serve a similar function in display unit 400 as structure 11 does for display unit 100, as described above. However, in contrast to one of structures 11 in stand piece 1, structure 28 may be positioned horizontally (left-to-right) rather than vertically (top-to-bottom) as for structure 11. That is, as shown in FIG. 23, structure 28 is rotated 90 degrees with respect to structure 11. In the example of display unit 400 shown in FIG. 23, structure 28 thus provides a groove or slot 29 and so forms a ledge with a lip, which is shaped, dimensioned, and positioned with respect to the roughened surface 3 to receive a bottom side of a lithophane 10 and enable the lithophane 10 to remain positioned in front of the roughened surface 3 of the pane 24 during use of display unit 400. The groove or slot 29 in structure 28 may be formed such that a snug fit for the bottom edge of lithophane 10 is sufficient to keep it in place while viewing, either with, or in the absence of, elastic bands 25 or other means for positioning lithophane 10 upon or proximate to the roughened surface 3 of pane 24. That is, inclusion of structure 28 in display unit 400 may dispense with the need to include elastic bands 25 or other functionally equivalent or similar means, at least for the bottom 2 corners of lithophane 10.

Referring now to FIG. 24, in addition to structure 28 positioned proximate to the bottom edge of the roughened surface 3, an opposing structure 31 may be positioned from left-to-right proximate to a top edge of roughened surface 3 to thereby provide a second groove or slot 29 for receiving the top edge of lithophane 10. In a technique similar to structures 11 with opposing slots 2 as described above for display unit 100, the two opposing structures 28 and 31 thus provide opposite facing grooves or slots 29 for holding a lithophane 10 positioned in front of the roughened surface 3. Furthermore, a user of display unit 400 is also able to conveniently switch out different lithophanes 10 by sliding them left or right out of the slots. In some embodiments each groove or slot 29 of the pair of opposing structures 28 and 31 extends left-to-right across the top and bottom edge of the roughened surface 3. In other embodiments, the variations on length and positioning described above with reference to FIG. 23 for structure 28 may apply in full or in part to structure 31. For example, and without limitation, some examples of display unit 400 illustrated in FIG. 24 may only utilize structures 28 and 31 positioned on pane 24 such that they engage on with 4 corners of a square-or rectangular-shaped lithophane 10. The grooves or slots 29 in structures 28 and 31 may be formed such that a snug fit for both the top and bottom edges of lithophane 10 is sufficient to keep it in place while viewing, either with, or in the absence of, elastic bands 25 or other means for positioning lithophane 10 upon or proximate to the roughened surface 3 of pane 24. As compared to the single structure 28 in the example of display unit 24 shown in FIG. 23, use of the two opposing structures 28 and 31 may more effectively dispense with any need for including elastic bands 25 or other means for positioning lithophane 10 upon or proximate to the roughened surface 3 of pane 24.

Referring now to FIG. 25, a left-to-right extending portion of pane 24 proximate to the aforementioned top edge or roughened surface 3 may include a slot 33 or like structure extending down from the frontward-facing surface of pane 24 and into its material of construction. In some embodiments, the slot 33 or like structure has dimensions and other characteristics that are sufficient to receive a portion of a backward-facing side of structure 31. For example, and without limitation, slot 33 or like structure may have a depth (from front-to-back) that is sufficiently less than a front-to-back length of structure 31 to enable the formation of groove or slot 29 when structure 31 is fully inserted into slot 33 or like structure during use of the display unit 400 embodiment shown in FIG. 25. Inclusion of slot 33 or like structure on pane 24 as described above with reference to FIG. 25 may facilitate removable coupling (e.g., by a removable snap fit or by way of a magnetic coupling) of structure 31 to pane 24, as opposed to, for instance, permanently coupling structure 31 to the surface of pane 24 or with pane 24 having structure 31 formed continuously with it. Notably, all of the description above regarding of use of slot 33 or like structure with pane 24 and structure 31 is applicable in all respects to structure 28.

As to the embodiments shown in FIGS. 23-25, the structures 28 and 31, along with their correspondingly described features on pane 24 (e.g., 33) may also be referred to herein as means for positioning lithophane 10 upon or proximate to the roughened surface 3 of pane 24.

In the examples shown in FIGS. 26-28, in particular, the frontward-facing surface of pane 24 may not be flush with the frontward-facing surface of frame 23, in contrast to the examples of display unit 400 described above with reference to FIGS. 23-25. Referring now to FIG. 27, and further to FIGS. 20 and 22, frame 23 of display unit 400 may include a slot 30 to removably receive a lithophane 10 for viewing according to the present technology. Slot 30 may provide an opening through the material of construction of the top (horizontal) side of frame 23 that extends entirely through a portion of the top of frame 23. From the opening thus provided by slot 30, opposedly facing grooves 36 down and into opposing interior—(e.g., center-ward) facing surfaces of the left and right (vertical) sides of frame 23, where such grooves 36 stop at the upwardly-facing surface of the bottom side of frame 23, as shown in FIGS. 27 and 28.

The opening provided by slot 30 may be sufficiently shaped and dimensioned to receive a lithophane 10 inserted into it, while the opposing grooves 36 help guide the lithophane 10 down into place and hold the sides of the lithophane 10 securely so it may remain positioned in front of the roughened surface 3 of pane 24 positioned just behind a vertical axis defined by the rearward-facing surfaces of slot 30 opening and grooves 36. The aforementioned positioning of pane 24 in the embodiments shown in FIGS. 27 and 28 is further described below with reference to FIG. 26. Meanwhile, FIG. 28 shows a lithophane 10 inserted into the opening provided by slot 30, and slid partly down to the top facing surface of the bottom side of frame 23 by way of grooves 36 (e.g., about two-thirds of the way down into place in front of the roughened surface 3 of pane 24). The embodiments shown in FIGS. 27 and 28 thus provide a framed display unit 400 for lithophanes 10 with the slot 30 opening and grooves 36 built into the frame 23 to securely, yet removably hold the lithophane 10 in place, and conveniently enable a user of display unit 400 to alternately insert and remove various lithophanes 10 for viewing according to the present technology.

As to the embodiments shown in FIGS. 27 and 28, the slot 30 opening and grooves 36 may also be referred to herein as means for positioning lithophane 10 upon or proximate to the roughened surface 3 of pane 24.

Referring again to FIG. 26, and additionally to FIGS. 23-25, 27 and 28, frame 23 may be positioned around the pane 24. In some embodiments, frame 23 may include an at least partially enclosed interior cavity for this purpose. In an example, frame 23 may be formed of at least two frame pieces and the aforementioned interior cavity may be provided upon the coupling together of the at least two pieces of frame 23 around the pane 24. In some embodiments, light source(s) 6 may be positioned adjacent to at least one edge 19 of pane 24, and associated power and any other electronics may be operably coupled to light source(s) 6, button(s) 5, and dial(s) or knob(s) 26 prior to pane 24 being positioned within (e.g., as shown in FIG. 26) or on (e.g., as shown in FIG. 23) frame 24.

Still referring to FIG. 26, in some embodiments, means for positioning lithophane 10 upon or proximate to the roughened surface 3 of pane 24 may be provided in part on a portion of the frontward-facing surface of pane 24 (e.g., as described above with reference to FIGS. 23-25) and also in part on a portion of a topward-facing surface of a bottom side of frame 23. In the non-limiting example illustrated in FIG. 26, display unit 400 may include the structure 31 positioned from left-to-right proximate to a top edge of roughened surface 3 to thereby provide a groove or slot 29 for receiving the top edge of lithophane 10, as described above with reference to FIGS. 25 and 25.

In the example shown in FIG. 26, the topward-facing surface of a bottom side of frame 23 may include a groove 37 formed into the material of construction of the aforementioned topward-facing surface of a bottom side of frame 23 such that groove 37 is positioned just in front of pane 24 to thereby prevent the bottom of lithophane 10 from slipping forward, thus enabling lithophane 10 to remain properly positioned in front of the roughened surface 3 of pane 24 for back illumination by light path 7. In an example, a spacing between the back edge of groove 37 and a front side of pane 24 positioned in frame 23 may be approximately equal to a thickness of the bottom of lithophane 10. In an example, a left-to-right length of groove 37 may be just approximately equal to, or just slightly longer than (e.g., 1-2 mm longer) than, the length of the bottom side of lithophane 10.

In another embodiment, rather than the presence of groove 37 in display unit 400, a ridge structure (substantially of the sort of structure and function as described above with reference to FIGS. 17B and 18 for ridge 27) may be formed on, and extend upward from, the aforementioned topward-facing surface of a bottom side of frame 23. In this embodiment, the lithophane 10 may be held in place on its top side by groove or slot 29 of structure 31 may be further held in place by gravity (and possibly also friction) upon the topward-facing surface the bottom side of frame 23 and the frontward-facing surface of pane 24 to thereby enable the lithophane 10 to rest in position (e.g., with the bottom edge of lithophane 10 at least partly abutting the ridge). In this case, the ridge on the topward-facing surface the bottom side of frame 23 may be positioned just in front of pane 24 to thereby prevent the bottom of lithophane 10 from slipping forward, thus enabling lithophane 10 to remain properly positioned in front of the roughened surface 3 of pane 24 for back illumination by light path 7. For instance, a spacing between the back edge of ridge and a frontward-facing surface of pane 24 may be approximately equal to a thickness of the bottom of lithophane 10. In an example, a left-to-right length of such ridge may be approximately equal to, or just slightly less (e.g., 1-2 millimeters) than a left-to-right length of the bottom of lithophane 10. In another example, a left-to-right length of ridge may be substantially less than a left-to-right length of the bottom of lithophane 10 (e.g., between 75% to 10% of the left-to-right length of the bottom of lithophane 10), and with the ridge generally centered in front of the aforementioned frontward-facing surface of pane 24. In some embodiments, a plurality of ridge structures may be dispersed and spaced in front of frontward-facing surface of pane 24, where, for example and without limitation, each instance of ridge in that case has a left-to-right length that is less than half the left-to-right length of the bottom of lithophane 10.

As to the embodiments described above with reference to FIG. 26, groove 37 (or alternatively the ridge), structure 31, and described features on pane 24 (e.g., 33) may also be referred to herein as means for positioning lithophane 10 upon or proximate to the roughened surface 3 of pane 24.

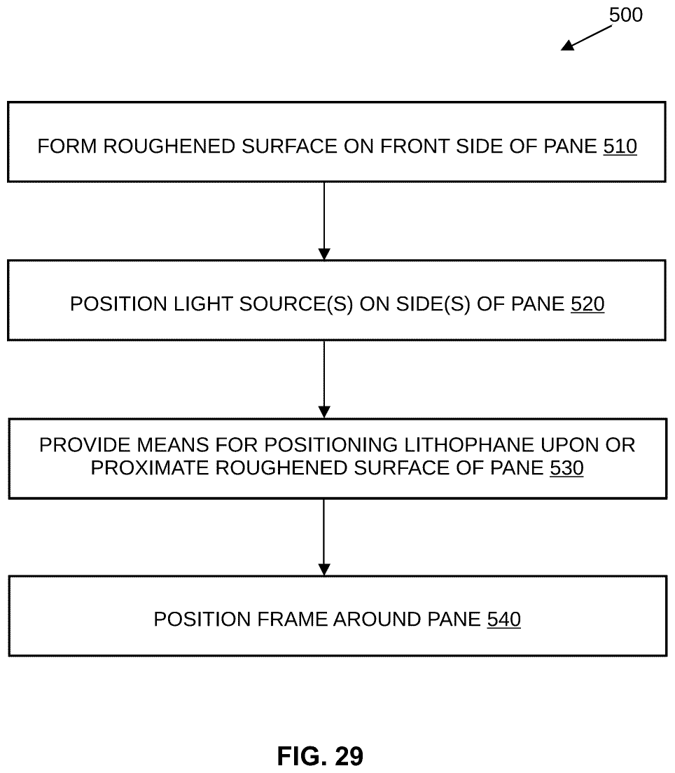

FIG. 29 is a flow chart of a method 500 of manufacturing a display unit for lithophanes (e.g., display unit 400) according to another embodiment of the present technology. Method 500 may include the step of forming 510 a roughened surface (e.g., 3) on a least a portion of a front side of a pane (e.g., 24). The pane 24 may be provided as a pane having a clear or translucent material of construction for purposes of method 500. Method 500 may include the step of positioning 520 at least one light source (e.g., 6) on at least one side or edge (e.g., 19) of the pane 24 sufficiently to direct light (e.g., of path 7) toward a center (e.g., 17) of the pane 24 through the edge(s) 19 of the pane 24. Method 500 may include the step of providing 530 means for positioning a lithophane (e.g., 10) upon or proximate to the roughened surface 3 of the front side of the pane 24. In some embodiments, method 500 may further include the step of positioning 540 a frame (e.g. 23) around the pane 24. Alternatively, or additionally, the positioning 540 step of method 500 may include the step of positioning pane 24 into a frontward-facing opening of the frame 23. Method 500 may further include the steps of positioning power supply and/or other electronics within an internal cavity of the frame 23, and operably coupling the power and/or other electronics to the light source(s) 6.

The above described display units 100, 300 and 400 for lithophanes 10 (and associated methods 200, 350 and 500, including the various embodiments thereof described by way of example with reference to the attached figures, address the above mentioned problems in the conventional devices and techniques for displaying lithophanes 10. By practicing the present technology, users of display units 100, 300 and 400 no longer need to choose between illuminating lithophanes 10 with either natural (e.g., daylight) or artificial (e.g., electric) light; rather, the user may utilize one of the display units 100, 300 or 400 as disclosed herein without having to move a lithophane 10 from place to place. Users of display units 100, 300 and 400 for lithophanes may thereby experience a heightened level of convenience and enjoyment in viewing lithophanes 10, and lithophanes 10 will not subject to excessive manual handling and are thereby more likely to remain intact for longer periods as compared to lithophanes 10 viewed using the conventional, known techniques. Additional and other advantageous practical advantages and beneficial technical effects flowing from practice of the present technology as disclosed herein are expected to be readily envisaged and appreciated in the fields of lithophane 10 viewing, as well as other fields where the present technology may find utility, by persons having ordinary skill in the art.

Unless the context clearly requires otherwise, throughout the description and the claims, the words “include,” “including,” “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while structures, components, steps, processes or blocks are presented in a given order, alternative embodiments may include, or may perform routines, having structures, components, steps, processes, or employ systems having blocks, in a different order, and some structures, components, steps, processes or blocks may be deleted, moved, added, subdivided, combined, and/or modified to provide alternative or sub-combinations. Each of these structures, components, steps, processes or blocks may be implemented in a variety of different ways. Also, while structures, components, steps, processes or blocks are, at times, shown as being arranged, or performed, in a series, these structures, components, steps, processes or blocks may instead be present or performed in parallel, or may be performed at different times. Further, any specific numbers noted herein are only examples: alternative implementations may employ differing values or ranges.

The teachings of the disclosure provided herein can be applied to other devices, systems, and methods, not necessarily the devices, systems, and methods described above. The elements and acts of the various embodiments described above can be combined to provide further embodiments.

Aspects of the disclosure can be modified, if necessary, to employ the devices, systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the disclosed devices, systems, and methods may vary considerably in their implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventor contemplates the various aspects of the disclosure in any number of claim forms. For example, while only one aspect of the disclosure is recited as a means-plus-function claim under 35 U.S.C. § 112(f), other aspects may likewise be embodied as a means-plus-function claim, or in other forms, such as being embodied in a computer-readable medium (Any claims intended to be treated under 35 U.S.C. § 112(f) will begin with the words “means for”). Accordingly, the applicant reserves the right to add additional claims after filing the application to pursue such additional claim forms for other aspects of the disclosure.

The Detailed Description provided herein may be applied to other devices, systems, and methods, not necessarily only the devices, systems, and methods described above. The elements and acts of the various examples described above can be combined to provide further implementations of the invention. Some alternative implementations of the invention may include not only additional elements to those implementations noted above, but also may include fewer elements. These and other changes can be made to the invention in light of the above Detailed Description. While the above description defines certain examples of the invention, and describes the best mode contemplated, no matter how detailed the above appears in text, the invention can be practiced in many ways. Details of the devices, systems, and methods may vary considerably in their specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention.

1. A display unit for lithophanes, the display unit comprising:
a pane, or a stand piece, formed of a clear or translucent material of construction, wherein at least a portion of a frontward-facing surface of the pane or of the stand piece includes a roughened surface formed thereon; and
at least one light source positioned sufficiently proximate to, or in contact with, one or more edges of the pane or of the stand piece, to direct light from the at least one light source into and through the clear or translucent material of construction toward the roughened surface.

2. The display unit of claim 1 comprising the stand piece having a top and a bottom, wherein the display unit further comprises:
a base having an opening formed in a portion of a top surface of the base; and
a receptacle extending downward from the opening and into a portion of the base.

3. The display unit of claim 2, wherein a material of construction of at least a portion of the base is an opaque material.

4. The display unit of claim 2, wherein the at least one light source is positioned at or proximal to a bottom of the receptacle.

5. The display unit of claim 4, wherein the bottom of the stand piece is configured to be inserted into the receptacle to bring the bottom of the stand piece in contact with or in proximity to the at least one light source.

6. The display unit of claim 2 further comprising means for positioning a lithophane upon, or proximate, to the roughened surface, wherein the means for positioning is disposed in or on at least one of:
a portion of the frontward-facing surface of the stand piece; and
a portion of the top surface of the base.

7. The display unit of claim 2, wherein at least a portion of a bottom surface of the base is flat.

8. The display unit of claim 1 further comprising a power supply operably coupled to the at least one light source.

9. The display unit of claim 8 further comprising means for alternately turning the at least one light source on and off positioned sufficiently to be accessible to a user during use of the display unit, and operably coupled to at least one of the power supply and the at least one light source.

10. The display unit of claim 1, wherein the at least a portion of the frontward-facing surface including the roughened surface is angled backward from front to back.

11. The display unit of claim 1, wherein the at least one light source comprises two or more light sources including a first light source positioned proximate to, or in contact with, to a first edge of the pane or of the stand piece, and at least a second light source positioned proximate to, or in contact with, to at least a second edge of the pane or of the stand piece.

12. The display unit of claim 1 comprising the pane, wherein the display unit further comprises a frame having a frontward-facing opening and configured to contain at least part of the pane such that the at least a portion of the frontward-facing surface of the pane including the roughened surface is viewable from an exterior of the frame through the frontward-facing opening of the frame.

13. The display unit of claim 12 further comprising means for positioning the lithophane upon, or proximate, to the roughened surface, wherein the means for positioning is disposed in or on at least one of:
a portion of the frontward-facing surface of the pane; and
a portion of the frame.

14. The display unit of claim 12, wherein a material of construction of at least a portion of the frame is an opaque material.

15. A display unit for lithophanes, the display unit comprising:
a pane formed of a clear or translucent material of construction, wherein at least a portion of a frontward-facing surface of the pane includes a roughened surface formed thereon;
a frame having a frontward-facing opening and configured to contain at least part of the pane such that the at least a portion of the frontward-facing surface of the pane including the roughened surface is viewable from an exterior of the frame through the frontward-facing opening of the frame; and
at least one light source positioned sufficiently proximate to, or in contact with, one or more edges of the pane to direct light from the at least one light source into and through the clear or translucent material of construction toward the roughened surface.

16. The display unit of claim 15 further comprising means for positioning a lithophane upon, or proximate, to the roughened surface.

17. The display unit of claim 16, wherein the means for positioning is disposed in or on at least one of:
a portion of the frontward-facing surface of the pane; and
a portion of the frame.

18. A method of manufacturing a display unit for lithophanes, the method comprising:
forming a pane, or a stand piece, of a clear or translucent material of construction, wherein forming the pane or the stand piece includes forming a roughened surface on at least a portion of a surface of the pane or of the stand piece that is frontward-facing during operation of the display unit; and
positioning at least one light source sufficiently proximate to, or in contact with, one or more edges of the pane or of the stand piece to enable, during operation of the display unit, light to be directed from the at least one light source into and through the clear or translucent material of construction toward the roughened surface.

19. The method of claim 18 further comprising forming or otherwise providing means for positioning a lithophane upon, or proximate, to the roughened surface.

20. The method of claim 18, wherein forming the pane, or the stand pieces comprises forming the pane, and wherein positioning the at least one light source sufficiently proximate to, or in contact with, the one or more edges of the pane or of the stand piece comprises positioning the at least one light source sufficiently proximate to, or in contact with, the one or more edges of the pane, the method further comprising:
forming or otherwise providing a frame having an opening that is frontward facing during operation of the display unit; and
positioning the pane sufficiently in or on the frame to be contained at least in part therein such that the at least a portion of the surface of the pane that is frontward-facing and includes the roughened surface is viewable from an exterior of the frame through the frontward-facing opening of the frame.
